(19) United States
(12) Patent Application Publication
(10) Pub. No.: US 2025/0251224 A1
(43) Pub. Date: Aug. 7, 2025

(54) SYSTEMS AND METHODS FOR TRIGGERING EXPLOSIVES IN HOLES

(71) Applicant: OLITEK PTY LTD, Queensland (AU)

(72) Inventors: Caleb Robinson, Queensland (AU); James Oliver, Queensland (AU); Nicholas Naranjo, Queensland (AU); Samuel Fogarty, Queensland (AU); Steve Hanwright, Queensland (AU)

(21) Appl. No.: 18/855,962

(22) PCT Filed: Apr. 11, 2023
(86) PCT No.: PCT/AU2023/050296

§ 371 Date: Oct. 10, 2024

(30) Foreign Application Priority Data
Apr. 11, 2022 (AU) 2022202388

(51) Int. Cl. F42B 3/26; B25J 5/00; B25J 9/16; F42D 1/04; F42D 1/22; F42D 3/04

(52) U.S. Cl. CPC F42B 3/26; B25J 5/007; B25J 9/1697; F42D 1/043; F42D 1/22; F42D 3/04

(57) ABSTRACT

Systems, methods and apparatus that facilitate mechanisation and/or automation of blasting processes in mining and civil engineering applications are disclosed. The disclosure includes a trigger assembly for triggering an explosive in a hole in rock. The disclosure also includes a mining or civil engineering vehicle for working proximate an end face. The vehicle comprises a positioning unit for moving a functional unit to a selected location in relation to the end face. The positioning unit can include (a) a coarse positioning module and a fine positioning module and/or (b) a vision module for monitoring the position of the functional unit to facilitate guiding the functional unit to the selected location and/or (c) can be configured to move independently from an initial position to a second position closer to the selected location whilst the vehicle remains stationary.

### TECHNICAL FIELD

The invention relates to systems, methods and vehicles for loading and triggering explosives in holes in underground and above-ground mining and civil engineering applications.

More particularly, although by no means exclusively, the systems, methods and apparatus of the invention facilitate mechanisation and/or automation of blasting processes.

### BACKGROUND

The following description of the invention is in the context of development tunneling for extending underground mine drives, for example in the extraction level of block cave mines.

However, it is emphasised that the invention is not limited to this application and extends generally to loading and triggering explosives in holes in any above-ground and underground applications, including, by way of example, drill and blast mining in benches in above-ground mines, up-hole and down-hole stope mining and civil tunneling applications, including development tunneling and production operations.

There is a desire to reduce manual processes and remove personnel from the task of loading and triggering explosives in blast holes in underground mine drives.

There is limited space in underground mine drives, and this space limitation has a significant impact on the development of drives, with conventional machinery and automation methods being unsuited to reduce manual processes and remove personnel.

Therefore, to enable mechanisation of a blasting process, there is a need for new methods and systems for loading explosives into blast holes within a rock face and for triggering said explosives.

Typically, in underground drive development, each blast may fracture and/or displace up to 200-400 tonnes of rock. Each blast may require explosives to be loaded into a plurality of distinct blast holes in an end face, i.e., heading of a drive. Typically, 70-80 drilled holes are required for a blast for larger drives. Fewer holes are typically required for smaller drives. The number of holes will vary depending on factors including geology, mineralogy, explosive selection, etc. Typically, in underground mine drive charging, blast holes range from 3-6 m deep with a hole size of 45-50 mm diameter, but the size and depth could be larger or smaller depending on the application and/or the explosive used.

Drive development speed is important. One typical mining operation allows 45 minutes for operators to position and tie-in explosion triggers, such as detonators, and emulsion for each blast sequence at a heading of a drive.

One conventional approach for extending underground mine drives is to:
(a) drill a plurality of holes into an end face (i.e. heading) of a drive;
(b) position explosives (typically—but not limited to—emulsion explosives) in the drilled holes;
(c) connect electric and/or non-electric detonators to the explosives within the holes in the face; and
(d) trigger the explosives via an activation system to produce explosive a blast.

This process is typically repeated multiple times to establish a drive of a required length.

This process typically requires several different operator-controlled vehicles at the end face. Moving multiple vehicles into an out of a drive that is being established is a time-consuming process.

A further factor is that vehicles working underground to carry out drill and blast operations must be located outside a high-risk zone in relation to a heading, typically at least 5 m from a heading—for safety reasons.

Step (c) of the above underground charge-up/blasting process generally includes either (i) a physical connection via a trigger cord (such as a detonator cord, electrical wire or non-electric shock (“nonel”) tube e.g. in the form of a small diameter tube for transporting an initiation signal to explosives by means of a percussive wave travelling the length of the tube) or (ii) a chemical reaction connection between an external trigger system and each explosion triggers, such as a detonator.

The explosion trigger (also described herein as a “trigger unit”) may be in any suitable form.

For example, the explosion trigger may be a detonator that itself may comprise a small explosive charge, such as a booster, also positioned within the hole. The term “small” means small in comparison with the detonation unit body of the blast-generating explosive. The detonator and the small explosive charge may be separate components or a single assembly.

In order to achieve a required blast, triggering explosives has to be tightly controlled. This requires accurate and careful locating of explosion triggers within holes. The selected location of an explosion trigger in any situation may be at an end or part way along the length of a hole.

One example of an explosion trigger is an assembly of a booster and a detonator.

The term “booster” is understood herein to mean a sensitive explosive charge that acts as a bridge between a relatively weak conventional detonator and a low sensitivity bulk explosive.

A challenge to the mechanisation and/or automation of charge loading systems is the placement of a plurality of explosion triggers in a plurality of holes at required locations in an end face without any or with minimal only physical, i.e., direct, personnel intervention.

A further factor is that current standards dictate that different classes of explosives must not be in intimate contact (assembled) until immediately before insertion into a hole. Typically, in situations where an explosion trigger is an assembly of a booster and a detonator, these components are different explosive classes and must be assembled immediately before insertion into a hole.

Insertion and connection of explosion triggers to respective explosives (typically, a two-wire system for explosion triggers, but could also be non-electric shock tube or a chemical reaction connection), as well as interconnection of explosion triggers to provide for a controlled blast of explosives in multiple holes, is difficult with a machine-based loading system, as there is lack of dexterity that a human operator offers, and that is generally required, during the conventional loading process.

Additionally, careful management of, for example, 40-60 loose detonator cords or other trigger cords protruding from charged blast holes in an end face per blast is difficult with a machine-based loading system for explosion triggers.

The invention provides a method and an apparatus for triggering explosives in holes in both underground and above-ground mines that is an alternative to current practices.

The above description is not an admission of the common general knowledge in Australia and elsewhere.

Unless defined otherwise, all technical and scientific terms used herein have the same meaning as commonly understood by one of ordinary skill in the art to which this invention belongs. Although any methods, vehicles and other equipment and devices, and materials similar or equivalent to those described herein can also be used in the practice or testing of the present invention, a limited number of the exemplary methods, vehicles and other equipment and devices, and materials are described herein.

### SUMMARY OF THE INVENTION

The invention is an improvement of conventional drill and blast operations in underground and above-ground mines, such as drill and blast mining in benches in above-ground mines, up-hole and down-hole stope mining in underground mines, including development tunneling and production operations.

As noted above, the invention also extends to other underground and above-ground applications, including, by way of example, civil tunneling applications.

Conventional drill and blast operations in underground mines (for example), such as a block cave mine, include forming holes for explosives in a heading of a drive in the block cave mine and subsequent placement of detonators and explosives in holes and then initiating the explosives to form development and production drives in an extraction level of the block cave mine.

The invention mechanises at least some of these conventional operations.

There are a number of different aspects to the invention, as follows:
1. The use of at least one mining or civil engineering vehicle for carrying out required operations to facilitate placement of explosion triggers such as detonators and/or explosives in drilled holes in a heading and then initiating the explosives, for example to form a drive, with the vehicle having an arm, such as an articulated arm (but could be any other suitable element for the functional requirement), that can support a functional unit(s) on an end of the arm, with the vehicle having a positioning unit that includes (a) a module (which could also be described as a system) for coarse positioning the functional unit(s) in relation to a hole and (b) a module (which could also be described as a system) on the end of the arm for fine positioning the functional unit(s) in relation to the hole. The coarse and fine positioning modules allow quick and safe deployment of the functional unit(s) to required locations so that the functional unit(s) can carry out required operations in relation to each hole. The coarse and fine positioning modules make it possible to align functional unit(s) to a selected hand-over point, for example, a small, typically 20-50 mm (but could be larger), drilled hole in a heading whilst operators remain a safe distance, typically at least 5 m away. At the hand-over point, a selected functional unit(s) is operable to carry out operations in relation to the heading, such as inserting trigger assemblies into holes. The coarse positioning module typically has a large operational reach and range of motion allowing it to position the functional unit(s) proximate the hole. The fine positioning module typically has a high resolution and more limited range of motion, thus enabling it to align and locate the functional unit(s) with respect to the hole within the heading. It is noted that the coarse and fine positioning modules may be a single module with two functions, namely coarse positioning and fine positioning functions.
2. As an alternative to item 1, the at least one mining or civil engineering vehicle may only need to operate with a fine positioning module to bring a functional unit(s) to a hand-over point, such a location for carrying out operations in relation to a heading, such as inserting trigger assemblies into holes.
3. The configuration of the functional unit(s) makes it possible to handle and deploy sensitive components such as detonators and other types of explosion triggers, via the functional unit(s) whilst the coarse and fine positioning modules of the vehicle itself remain stationary or “parked”. This may include picking up trigger assemblies from storage compartments. This may also include inserting trigger assemblies into holes in a heading. This combination of coarse positioning, fine positioning, and hand-over via the functional unit(s) provides significant advantages over conventional explosives handling systems. For example, the applied torques and forces acting on the sensitive components are only those of the functional unit(s) itself, and thus are far lower than those of the coarse and fine positioning modules of the vehicle itself.
4. A trigger assembly for triggering an explosive in a blast hole to produce an explosive blast that is configured to be located in a hole in an end face, i.e., heading, and includes a connection unit that simplifies the process for connecting an external explosive activation system to a detonator of the trigger assembly for initiating an explosive in the hole.
5. Methods and systems for loading the trigger assemblies into the blast holes and for connecting the trigger assemblies to an external explosive activation system.

The aspects of the invention are described further below, albeit in a different order to the items in the above list.

### A. Trigger Assembly—Detonation Cord

In one aspect, the invention relates to a trigger assembly for triggering an explosive in a hole in rock to produce an explosive blast, the trigger assembly being configured to be located in a hole in rock, for example in an end face, i.e., heading, of a drive, the trigger assembly including:
(a) a detonation unit body configured to be located at or proximate an open end of the hole;
(b) a trigger unit (described above as an explosion trigger) locatable at least partially within the detonation unit body for triggering the explosive in the hole, the trigger unit including a trigger cord connected to a proximal end of the detonation unit body; and
(c) a connection unit for connecting a detonation cord of an external explosive activation system to the trigger unit to facilitate triggering an explosion in the hole.

The term “trigger cord” is understood herein to include, by way of example, (a) a detonator cord, (b) an electrical wire or (b) a non-electric shock tube (a Nonel tube) e.g., in the form of a small diameter tube for transporting an initiation signal to explosives by means of a percussive wave travelling the length of the tube.

The connection unit may be configured to receive the detonation cord of the external explosive activation system and to physically connect the detonation cord to the trigger cord when coupled thereto.

In one embodiment, the connection unit may comprise an element, such as a resilient element, to receive and connect the detonation cord to the trigger cord.

The resilient element may be any suitable form that can receive and connect the detonation cord to the trigger cord and takes advantage of the resilience of the element to facilitate connecting the detonation cord to the trigger cord.

By way of example, the resilient element may comprise a generally key-hole shaped passage with two opposed open sides and two opposed closed sides, with the passage having a circular base section for receiving and connecting the detonation cord to the trigger cord and a narrower width elongate throat section that communicates at one end with the circular base section and has an opening at the other end through which, in use, the detonation cord can be moved into the throat section and along the throat section to the circular base section and contact the trigger cord.

The resilient element may comprise a base and a pair of opposed arms extending from the base that define the passage, with the base defining the circular base section and the arms defining the throat section.

The arms may be resilient arms such that inserting the detonation cord into the opening and moving the detonation cord through the throat section to the circular base section forces the arms apart from an original position against the resilience of the arms, with the arms returning to the original position after the detonation cord is in the circular base section, with the returned arms in the original position resisting release of the detonation cord from the circular base section and contributing to retaining the detonation cord in contact with the trigger cord.

In another, but not the only other, embodiment the connection unit may be configured to be moveable relative to the detonation unit body from a first inoperative position, in which the detonation cord of the external explosive activation system is not connected to the trigger unit, to a second operative position, in which the detonation cord is connected to the trigger unit.

By way of example, the connection unit may include a sleeve that fits over a proximal end of the detonation unit body as viewed looking at the hole, the sleeve being configured to receive the detonation cord and to physically connect the detonation cord to the trigger cord when coupled thereto.

By way of example, the sleeve may be moveable relative to the detonation unit body from the first inoperative position, in which the detonation cord is not connected to the trigger cord, to the second operative position, in which the detonation cord is connected to the trigger cord of the trigger assembly.

When the sleeve is in the second operative position, the detonation cord may be secured between the sleeve and the detonation unit body in contact with the trigger cord of the trigger assembly.

The connection unit and the detonation unit body may include complimentary mating members that can guide the connection unit and the detonation cord from the first inoperative position to the second operative position and bias together the trigger cord and the detonation cord in the second operative position.

The complimentary mating members may comprise (i) a plurality of projecting members that extend axially away from a proximal end of the sleeve and define a plurality of channels therebetween for receiving the detonation cord and (ii) a plurality of posts that extend from the proximal end of the detonation unit body and define slots therebetween, with the channels and the slots being aligned axially when the connection unit is in the first inoperative position.

Each projecting member may be shaped to have a taper from a tip of the projecting member, with the width of the projecting member increasing with distance from the tip, with the increasing width of the taper guiding the detonation cord into a channel.

The projecting members may be spade-shaped (or any other suitable shape).

The projecting members may include a notch for receiving the detonation cord when the connection unit is in the second operative position after being guided into the channel, with the detonation cord being held in contact with the trigger cord of the trigger assembly when in the notch.

The posts may be configured to cause rotational and axial movement of the connection unit with respect to the detonation unit body when the connection unit is moved relative to the detonation unit body from the first inoperative position to the second operative position, with this movement facilitating movement of the detonation cord located in one of the channels into contact with the trigger cord.

Each post may include a ramp that defines a cam surface for the projecting members to move along when the connection unit is moved axially towards the detonation unit, with the movement of the projecting members along the ramps causing the rotational and axial movement.

In-use, the detonation cord may be received between a first pair of projecting members and a second pair of projecting members of the connection unit and contact the trigger cord of the trigger assembly and extend from the connection unit to a second connection unit of a second trigger assembly, the trigger cord being received between first and second pairs of projecting members of the second connection unit and contact the trigger cord of the second trigger assembly. These connections may be repeated so that the detonation cord connects together a plurality of the trigger assemblies in the end face.

The connection unit and the detonation unit body may include complimentary engagement members that couple the connection unit to the detonation unit body.

The engagement members may include plurality of tabs of the connection unit that engage within grooves of the proximal end of the detonation unit body when the connection unit is coupled thereto, to form a one-way connection therewith.

The tabs may be disposed within apertures located at or towards a distal end of the connection unit.

The apertures may facilitate insertion of a clip member to disengage the tab members from the groove and allow uncoupling of the connection unit from the detonation unit body.

### B. Trigger Assembly—Wireless Receiver

In another aspect, the invention relates to a trigger assembly for triggering an explosive in a hole in rock to produce an explosive blast, the trigger assembly being configured to be located in a hole in rock, for example a hole in an end face, i.e., heading, of a drive, the trigger assembly including:
(a) a detonation unit body configured to be located at or proximate an open end of the hole;
(b) a trigger unit (also described as an explosion trigger) locatable at least partially within the detonation unit body for triggering the explosive in the hole; and
(c) a connection unit for connecting an external explosive activation system to the trigger unit to facilitate triggering an explosion in the hole, the connection unit including a wireless receiver in communication with the external activation means that may be triggered by laser, WiFi, Bluetooth or another communication medium.

The connection unit and/or the trigger assembly may include a power source such as a battery to power the receiver.

### C. Trigger Assembly—General

In relation to both embodiments, the detonation unit body of the trigger assembly may include a compartment for housing the trigger unit of the trigger assembly.

As noted above, the trigger cord of the trigger assembly may include, by way of example, (a) a detonator cord, (b) an electrical wire or (c) a non-electric shock tube e.g., in the form of a small diameter tube for transporting an initiation signal to explosives by means of a percussive wave travelling the length of the tube.

The trigger unit of the trigger assembly may also include (i) a booster that includes a small explosive charge, typically a small explosive charge compared to the rock mass to be blasted and (ii) a detonator for detonating the small explosive charge. It is noted that the trigger unit (also described as an explosion trigger) may be any suitable trigger unit and is not confined to detonator/booster arrangements.

The booster may include an elongate chamber for receiving the detonator such that the booster is insertable into the detonation unit body after the detonator is already installed therein.

The trigger unit may include a carrier configured to mount the detonator, the booster and the trigger cord in the compartment.

The carrier may be configured to be inserted into and close an open end of the detonation unit body so that the detonator and the booster are located in the housing.

The carrier may be detachable from the detonation unit body to thereby open the compartment and release the trigger unit when a force in excess of a threshold force is applied thereto.

The trigger assembly may comprise an adaptor that can cooperate with the carrier to facilitate use of the trigger assembly with any suitable trigger unit.

The trigger assembly may include a retaining means for retaining the detonation unit body at an initial position within the hole towards the open end thereof.

The retaining means may include a wider diameter section compared to the diameter of the detonation unit body.

In one embodiment, the retaining means may include a collar or other suitable member that has a wider diameter than the diameter of the detonation unit body and is configured to engage a section of an internal wall of the hole near the open end of the hole.

The retaining collar may be disposed around the housing of the detonation unit body and be configured to (a) engage the section of the internal wall of the hole to prevent axial movement relative to the housing and (b) allow the detonation unit body to rotate about a central longitudinal axis of the housing in use when the trigger cord is unwound as the carrier moves forwardly from the initial position in the hole away from the detonation unit body.

In another embodiment, the retaining means may include a collar that is mounted on the detonation unit housing and has (i) a locating flange to contact a section of the heading that defines the hole, and (ii) a resilient biasing element that is configured to contact the side wall of the hole and hold the trigger assembly in position in the hole.

Alternatively, the collar may only provide the biasing element and the locating flange may be incorporated into the detonation unit body.

The collar may be mounted for relative rotational movement about a longitudinal axis of the detonation unit body to allow the body to rotate as the trigger cord is unwound as the carrier moves forwardly from the initial position in the hole away from the detonation unit body.

The trigger assembly may be configured such that the trigger unit can be moved forward into the blast hole to a desired detonation position whilst the detonation unit remains in the initial position, with the trigger cord (when present) unwinding to maintain the physical connection between the detonation unit body and the trigger unit so that the trigger unit can be activated by the activation means to thereby trigger the explosive in the hole and produce the explosive blast.

The detonation unit body may include an elongate housing that defines the compartment and is configured to extend into the hole and to receive and support the trigger unit within the compartment in the initial position of the trigger assembly in the hole.

The elongate housing may include a first housing section that, in use, is located outside the hole and provides a sleeve-like (which may be described as spool-like) housing around which the trigger cord is wound.

The elongate housing may include a first housing section that, in use, is located inside the hole and provides a sleeve-like (which may be described as spool-like) housing around which the trigger cord is wound.

### D. Method of Triggering an Explosive Blast

In another aspect, the invention provides a method of triggering an explosive blast within rock, for example rock at an end of a drive in an extraction level of an underground block cave mine, the rock having a plurality of holes formed therein, the method comprising:
(a) positioning a detonation cord of an external explosive activation system in relation to the connection unit of the above-described trigger assembly,
(b) physically connecting together the detonation cord and the trigger unit of the trigger assembly, and
(c) triggering an explosive within the trigger assembly to thereby initiate the explosive blast with the external activation means.

The method may include repeating steps (a) and (b) successively in relation to a plurality of other trigger assemblies and thereby connecting together the trigger assemblies with the detonation cord before carrying out step c).

### E. Mining or Civil Engineering Vehicle

In another aspect, there is provided a mining or civil engineering vehicle for working proximate an end face, for example proximate an end face, i.e. a heading, of a drive, the vehicle comprising: a positioning unit for moving a functional unit described further below, to a selected location, for example a hole in the end face, the positioning unit including: (i) a coarse positioning module (which can also be described as a system) configured to position the functional unit proximate the selected location, such as the hole in the end face, and (ii) a fine positioning module (which can also be described as a system) configured to facilitate adjustment of the position of the functional unit to locate and align the functional unit more accurately in relation to the selected location, such as the hole.

In one embodiment, two vehicles are used, with one optimised for hole and heading cleaning functions and the other optimised for trigger assembly and emulsion delivery and detonation cord tie-in functions.

In another embodiment, one vehicle is used.

The selected location may be the above-mentioned hole in the end face. The selected location may be any other location in the end face. The selected location may be any other required location, for example in a location to pick-up a trigger assembly stored on the vehicle.

The positioning unit may include a control system that can track the selected location, such as the hole, for example by video servo methods or similar hole monitoring options, and operate the fine positioning module to adjust, typically continuously, the position of the functional unit. This feature enables (once in position) the fine positioning module to “float” in a “correct” position if the vehicle moves for any reason and keep the functional unit aligned with the selected location.

The positioning unit may further include a vision module for monitoring the position of at least one of the coarse positioning module and the fine positioning module to facilitate guiding the functional unit to the selected location.

The vision module may comprise a first range sensor mounted to a body of the vehicle.

The vision module may further comprise a second range sensor mounted to the fine positioning module.

In one embodiment, the positioning unit may include a vision module comprising:
a first vision-based system on the vehicle to monitor the position of the coarse positioning module in relation to the selected location; and
a second vision-based system on the end of the fine positioning module to monitor the position of the fine positioning module in relation to the selected location.

The fine positioning module may be coupled to the coarse positioning module.

The coarse positioning module may comprise an articulated arm.

The fine positioning module may comprise a hub configured to be coupled to the functional unit and a plurality of elongate links, with each link being connected at one end to the hub.

Each of the links may be independently moveable such that the hub is translatable and rotatably moveable with respect to the vehicle.

The hub may include an aperture that, in use, is aligned co-axially with the hole.

The positioning unit may be operator-controlled, for example when in a cabin of the vehicle or tele-remotely, or autonomously controlled or semi-autonomously controlled.

In some embodiments, the vehicle may include at least one functional unit that is configured to carry out a series of tasks in relation to an end face and holes in the end face, such as preparing and loading a selected trigger assembly into a hole in the end face.

The at least one functional unit may be configured to move the trigger assembly with respect to the end face independently of the positioning unit of the vehicle.

The at least one functional unit may be configured to move the trigger assembly with respect to the end face independently of the coarse positioning module of the vehicle.

The at least one functional unit may be coupled to the fine positioning unit and be configured to move the trigger assembly with respect to the end face independently of the coarse positioning unit of the vehicle.

The vehicle may include a first functional unit, typically couplable to the fine positioning module, and configured to support a selected trigger assembly for example when the trigger assembly is moved to an aligned position in relation to a hole and when the trigger assembly is moved to an initial position within the hole.

The vehicle may include a housing for storing a plurality of the trigger assemblies.

The first functional unit may include (a) a housing for protecting the selected trigger assembly in use of the functional unit to position the selected trigger assembly in the hole and (b) gripper unit positioned at an opening of the housing, with the gripper unit being movable between closed and open positions to allow insertion of a trigger assembly into the housing.

The first functional unit may include a moveable member that, in-use, is moved co-axially with the hole to move the selected trigger assembly from a pre-insertion position proximate the hole to the initial position within the hole.

The first functional unit may include an insertion mechanism operable to move a detachable portion of the selected trigger assembly forward from the initial position to an operative position within the hole.

The insertion mechanism may comprise an emulsion charging hose that unspools to push the detachable portion from the initial position to the operative position. The emulsion charging hose may extend through the aperture of the base of the fine positioning module.

The functional unit may be a second functional unit in the form of a tie-in module that is couplable to the fine positioning module and configured to connect the detonation cord to the trigger assemblies after the trigger assemblies are located in the holes.

The tie-in module may include a moveable head that is engageable with a fixed portion of the selected trigger assembly. In use, forward movement of the moveable head may secure the detonation cord to the trigger assembly.

The head may include a guide through which the detonation cord is fed towards the fixed portion of the selected trigger assembly.

The head may be disc-shape and the guide may be centrally located therewith, such that, in use, the guide is located coaxially with respect to the hole when connecting the detonation cord to the trigger assembly.

The tie-in module may include a rotatable drum from which the detonation cord is selectively dispensable.

In some embodiments the vehicle may be configured to clean and inspect the hole and/or the rock face surface proximate thereto in preparation of insertion of the trigger assembly.

The functional unit may be a third functional unit, typically couplable to the fine positioning module, and configured to clear debris from the rock face surface proximate the hole.

The third functional unit may include a rake member configured to be drawn along the rock face surface to thereby wipe debris clear of the hole.

The functional unit may be a fourth functional unit couplable to the fine positioning module and configured to clear debris from within the hole.

The fourth functional unit may include a first hose that is selectively fed from a rotatable spool into the hole to measure a depth thereof. A terminal end of the first hose may provide an air jet for clearing light debris from the hole. The air jet may face away from the terminal end of the respective hose, such that debris is propelled towards the opening of the hole.

The fourth functional unit may include a second hose having a terminal end configured to grasp heavy debris and remove it from the hole.

The vehicle may further comprise a separate storage compartment for storing each of the functional units.

In another aspect, there is provided a mining or civil engineering vehicle for working proximate an end face, i.e. a heading, of a drive, the vehicle comprising: a positioning unit for moving a functional unit described above with respect to a selected location, the positioning unit including: a vision module for monitoring the position of the functional unit(s) to facilitate guiding the functional unit to the selected location.

In another aspect, there is provided a mining or civil engineering vehicle comprising a functional unit for working an end face, the vehicle being configured to move a functional unit described above to an initial position proximate a selected location, and the functional unit being configured to move independently from the initial position to a second position closer to the selected location whilst the vehicle remains stationary.

Various features, aspects, and advantages of the invention will become more apparent from the following description of embodiments of the invention, along with the accompanying drawings in which like numerals represent like components.

### BRIEF DESCRIPTION OF THE DRAWINGS

Embodiments of the invention are illustrated by way of example, and not by way of limitation, with reference to the accompanying drawings, of which:

FIGS. 1a and 1b illustrate a trigger assembly according to an embodiment of the invention, showing the main components thereof, namely: a detonation unit body, a trigger cord, a connection unit and a trigger unit that is accommodated within the detonation unit body;

FIG. 2 is a front view of a section of an end face of a drive of an underground mine, illustrating a plurality of the FIGS. 1a and 1b trigger assemblies inserted into drilled holes in the end face and a plurality of hard-wired connections in a daisy chain arrangement between detonators of the trigger assemblies and an activation system (not shown);

FIGS. 3a and 3b are diagrammatic sectional views of the trigger assembly of FIG. 1 in-use, illustrating the trigger unit thereof being moved from an initial position in the hole to a detonation position along the hole;

FIGS. 4a to 4d are perspective views of the detonation unit body of the trigger assembly as shown in FIG. 3a, and components thereof;

FIG. 5 is a perspective view of the detonation unit body of FIG. 4a, showing a trigger cord being fed through a passage therein as a part of a process of assembling the trigger assembly shown in the Figure;

FIGS. 6a and 6b are perspective views of a collar that, in use, is fitted to the detonation unit body;

FIGS. 7a to 7d show a process of assembling the trigger unit of the trigger assembly, the process comprising inserting a booster into the detonation unit body, the booster enveloping a detonator previously fitted therein;

FIGS. 8a and 8b are perspective views of the connection unit of the trigger assembly, according to an embodiment thereof;

FIGS. 9a and 9b are perspective views showing a clip member being inserted into an aperture of the connection unit of FIG. 10a, to facilitate removal of the connection unit from the detonation unit body;

FIGS. 10a to 10c are side views illustrating a process by which the connection unit is coupled to the detonation unit body;

FIG. 11 is an isometric view of an embodiment of a vehicle in accordance with the invention that can be used to prepare the rock face and blast hole for receiving the trigger assembly;

FIG. 12 is an isometric view of an embodiment of another vehicle in accordance with the invention that can be used to insert the trigger assembly into the blast hole;

FIGS. 13a to 13c are perspective views of a functional unit for use with the vehicle of FIG. 11, the functional unit comprising a rake member for cleaning the rock face;

FIGS. 14a to 14 c are perspective views of another functional unit for use with the vehicle of FIG. 11, comprising a hose that is used to remove debris from a blast hole;

FIG. 15 is an isometric view of a slider of the vehicle shown in FIG. 12 that is used for supporting and loading trigger assemblies;

FIGS. 16a to 16e illustrate another functional unit for use with the vehicle of FIG. 12, comprising a gripper that is used to load the trigger assembly in the blast hole, and a process by which the gripper is used to transport the trigger assembly from the vehicle to a detonation position within the hole;

FIGS. 17a and 17b illustrate another functional unit for use with the vehicle of FIG. 12, comprising a tie-in module that is used to connect together a plurality of trigger assemblies via a detonation cord;

FIGS. 18a to 18d illustrating a process by which the tie in module of FIGS. 17a and 17b is used to physically connect the detonation cord to the trigger assembly;

FIGS. 19a and 19b illustrate the tie in module of FIGS. 17a and 17b being used to interconnect a plurality of trigger assemblies;

FIGS. 20 and 21 are side and perspective views, respectively, that illustrate a trigger assembly according to another, although not the only other, embodiment of the invention;

FIGS. 22 and 22a are cross-sectional views of the trigger assembly shown in FIGS. 20 and 21 in an operative and pre-assembled configurations;

FIG. 23 is an enlarged perspective view of the connection unit at one end of the trigger assembly shown in FIGS. 21 and 22;

FIG. 24 is the enlarged perspective view of the connection unit shown in FIG. 22 with a detonation cord of an external explosive activation system retained by the connection unit;

FIG. 25 is a side view of the trigger assembly shown in FIGS. 20 to 24 that illustrates the components of the trigger assembly; and

FIG. 26 is a side view of the trigger assembly shown in FIGS. 20 to 25 positioned in an opening of a drilled hole in an end face of a drive of an underground mine.

### DETAILED DESCRIPTION

Embodiments will now be described more fully hereinafter with reference to the accompanying drawings, in which various embodiments, although not the only possible embodiments, of the invention are shown. The invention may be embodied in many different forms and should not be construed as being limited to the embodiments described below.

The invention relates generally to triggering explosives in holes in underground and above-ground mines and in civil engineering applications, such as drives.

The invention relates particularly, although by no means exclusively, to triggering explosives in holes in underground mines, such as:
a) in the development of horizontally extending drives in underground mines for the purpose of blasting rock and extending the drives, or
b) for mine production purposes that require explosives and detonators to be placed in a combination of angled, horizontal or vertical for the purpose of blasting rock (e.g. block cave development/infrastructure development.

The following description is in the context of underground block cave mines.

It is understood that the vehicles, methods and trigger assemblies described herein also have application in other civil engineering and mining applications, for example civilian tunneling and stope mining.

### Terminology

“drive”—with back (i.e. roof), sides, and shoulder that transitions a side to a roof.
“heading”—end face of drive to be drilled and blasted.
“burn”—central section of a heading that is detonated first. The rock expands on blasting and slumps out of the heading. The outer sections of the heading are detonated, and rock successively falls inwardly.

In broad terms, there is a number of different aspects to the invention, as follows:
1. The use of at least one mining or civil engineering vehicle for carrying out required operations to facilitate placement of detonators and explosives in drilled holes in a heading and then initiating the explosives, for example to form a drive, with the vehicle having an arm, for example an articulated arm, equipped with a functional unit on an end of the arm, with the vehicle having a positioning unit that includes (a) a module (which could also be described as a system) for coarse positioning the functional unit(s) in relation to a hole and (b) a module (which could also be described as a system) on the end of the arm for fine positioning the functional unit(s) in relation to the hole. A functional unit is essentially a tool or end-effector that is configured to undertake a particular function or task related to working/cleaning the heading and/or loading the trigger assembly into the drilled hole and connecting a detonation cord to multiple trigger assemblies. The coarse and fine positioning modules allow quick and safe deployment of the functional unit(s) to required locations so that the functional unit(s) can carrying out required operations in relation to each hole. The functional units may, in some cases, themselves be configured to be moveable independently of the fine and coarse positioning modules of the vehicle. The coarse and fine position modules make it possible to align functional units to a selected hand-over point, for example, a small, typically 40-50 mm, drilled hole in a heading whilst operators remain a safe distance outside a high-risk zone in relation to a heading, typically at least 5 m away from the heading. At the hand-over point, a selected functional unit(s) is operable to carry out operations in relation to the heading, such as inserting trigger assemblies into holes. The coarse positioning module typically has a large operational reach and range of motion allowing it to position the functional unit(s) proximate the hole. The fine positioning module typically has a high resolution and more limited range of motion, thus enabling it to align and locate the functional unit(s) with respect to the hole within the heading. It is understood that the coarse and fine positioning modules combine heavy and light “touch” movements.
2. The configuration of the functional units makes it possible to handle and deploy sensitive components such as detonators via the functional units whilst the coarse and fine positioning modules of the vehicle itself remain stationary or “parked”. This may include picking up trigger assemblies from storage compartments. This may also include inserting trigger assemblies into holes in a heading. This combination of coarse positioning, fine positioning, and hand-over via the functional unit(s) provides significant advantages over conventional explosives handling systems. For example, the applied torques and forces acting on the sensitive components are only those of each functional unit itself, and thus are far lower than those of the coarse and fine positioning modules of the vehicle itself. In some cases, the forces and torques are orders of magnitude lower to facilitate safe handling practices.
3. A trigger assembly for triggering an explosive in a blast hole to produce an explosive blast that is configured to be located in a hole in an end face, i.e., heading, and includes a connection unit that simplifies the process for connecting an external explosive activation system to a detonator of the trigger assembly for initiating an explosive in the hole.
4. Methods and systems for loading a plurality of the trigger assemblies into the holes and for connecting the trigger assemblies to a detonation cord of an external explosive activation system.

### Overview of the Embodiments of the Trigger Assembly

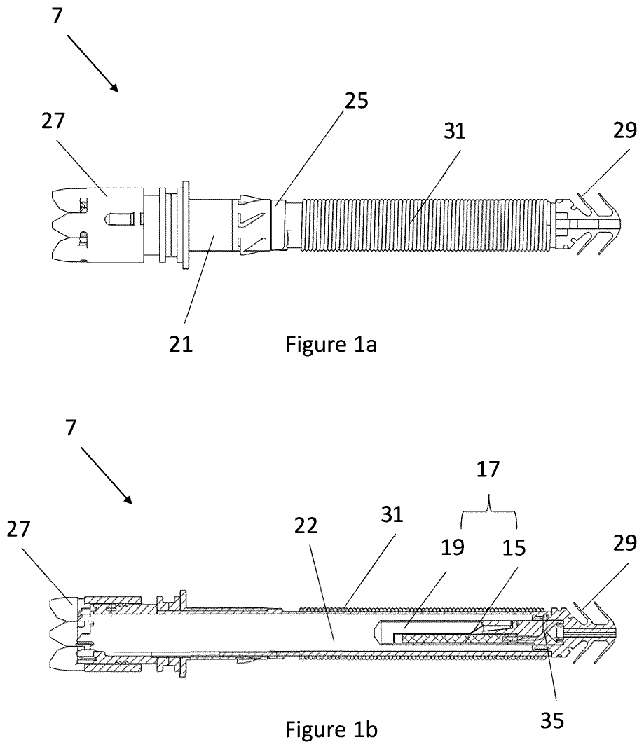

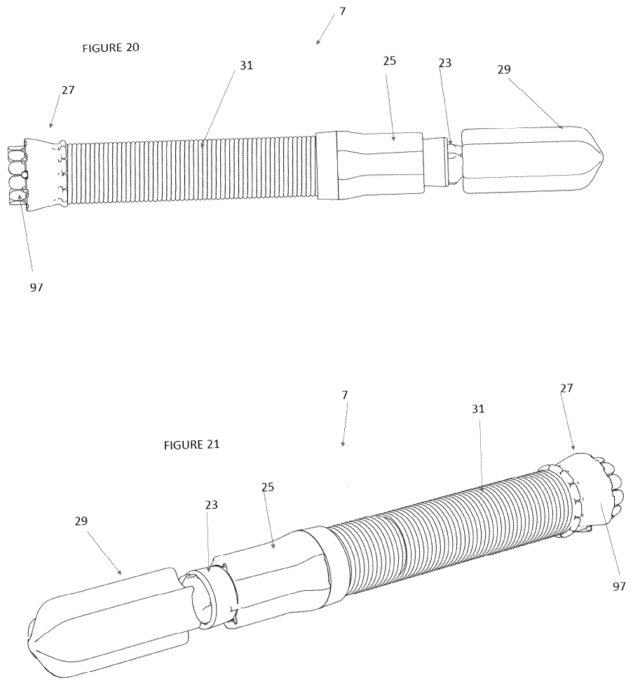

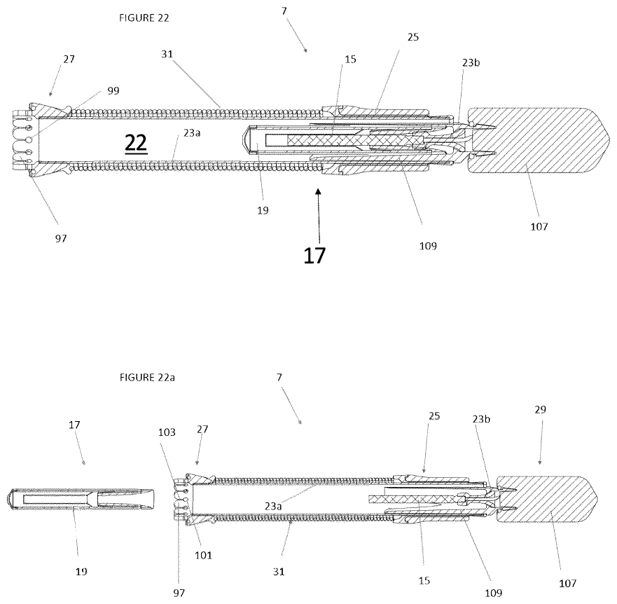

The embodiments of the trigger assembly shown in FIGS. 1-10 and in FIGS. 20-26 are improvements of the trigger assembly shown in international publication WO 2020/232506. The disclosure in the international publication is incorporated herein by cross-reference.

Embodiment of the trigger assembly shown in FIGS. 1-10

### Overview—FIGS. 1-10

With reference to FIGS. 1a to 1b, the main components of the embodiment of an_assembly for triggering an explosive in a blast hole to produce an explosive blast (i.e., “trigger assembly”) shown in FIGS. 1-10 are as follows:
(a) Detonation body unit 21—in an assembled trigger assembly, a trigger cord 31 in the form a nonel cord (or any other suitable trigger option) is wrapped around the circumference of the detonation unit body. The detonation unit body includes a rearwardly opening perimeter channel at a proximal end of the detonation unit body for receiving a section of the nonel cord. The nonel cord extends around the whole of the perimeter for contact at both ends to a section of a detonation cord of an external explosive activation system when positioned to extend across the opening, irrespective of the orientation of the detonation cord in relation to the crown.
(b) A trigger unit 17 in the form of a booster 19, a detonator 15, and the above-mentioned nonel cord that forms the trigger cord 31. The nonel cord is connected (i) at one end to the detonator 15 and (ii) at the other end to the proximal end of the detonation unit body, with the nonel cord positioned to be contacted by a detonation cord of the above-mentioned external activation system when the connection unit is moved from an initial position to a locked position, as described further below. The detonation unit body includes an opening in the wall and an internal channel for a section of the nonel cord that extends between the section of the nonel cord that is wrapped around the detonation unit body and the section of the nonel cord that is connected to the connection unit.
(c) Carrier 29—located at a forward end of the detonation unit body and configured to mount a detonator and a trigger cord, in this instance a non-electric cord, connected at one end to the detonator.
(d) Retaining means which, in the described FIGS. 1-10 embodiment, is provided, at least in part, by way of a collar—mounted on the detonation unit body. The collar may have (i) a locating flange to contact a section of the heading that defines the hole, and (ii) a resilient biasing element configured to contact the side wall of the hole and hold the trigger assembly in position in the hole. In other embodiments, the flange may be incorporated into the detonation unit body itself. In addition, the collar is mounted for relative rotational movement about the detonation unit body to allow the body to rotate as the trigger cord, such as a nonel cord, is unwound as the carrier moves forwardly from the initial position in the hole away from the detonation unit body—the collar facilitates efficient unwrapping of the trigger cord from the detonation unit body—accommodates built-in resilience of the trigger cord.
(e) Connection unit 27—located at a rearward end of the trigger assembly. The connection unit is configured to provide a connection between the trigger unit 17 and an external activation means that is used to trigger (i.e., fire) the booster. In the embodiment illustrated in FIGS. 1-10, the connection unit is configured to respond to axially forward rotational movement about the axis from an initial position to a locked position, with the movement moving a detonation cord to be in physical contact with the nonel cord. The connection unit includes a plurality of channels between rearwardly-extending projections of the connection unit, with the channels being formed to receive a detonation cord of an external initiation system so that the detonation cord extends across a central hollow section of the connection unit and positions the detonation cord to be moved as described above to contact the nonel cord. The connection unit is configured so that there is a predetermined clamping force between the nonel cord and the detonation cord to prevent pinching or other damage to the detonation cord and the nonel cord that could compromise detonation. The connection unit includes a compressible element that is responsive to the clamping force applied by the detonation cord to control the clamping force. In other embodiments (not shown), the connection unit may include a wireless receiver that that provides a wireless connection between the trigger unit 17 of the trigger assembly 7 and the external activation means.

### The Trigger Assembly 7—FIGS. 1-10

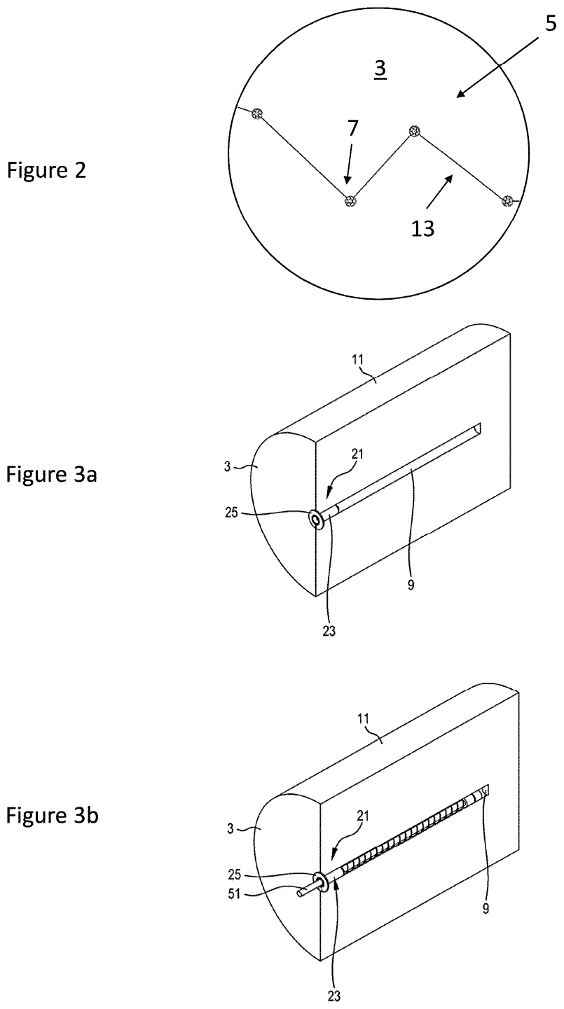

FIG. 2 is a front view of a section of an exposed end rock face 3, i.e., heading, of a drive 5 in an extraction level of an underground block cave mine with a plurality of trigger assemblies 7 in drilled holes 9 (see FIGS. 3a and 3b) extending into a rock mass 11 in the end rock face 3 interconnected via a detonation cord 13 in a daisy chain arrangement to an activation system (not shown).

It is noted that the invention is not confined to the arrangement of drilled holes 9 and the daisy chain arrangement of the detonation cord 13 and extends to any suitable arrangements of the drilled holes 9 and the detonation cord/s 13.

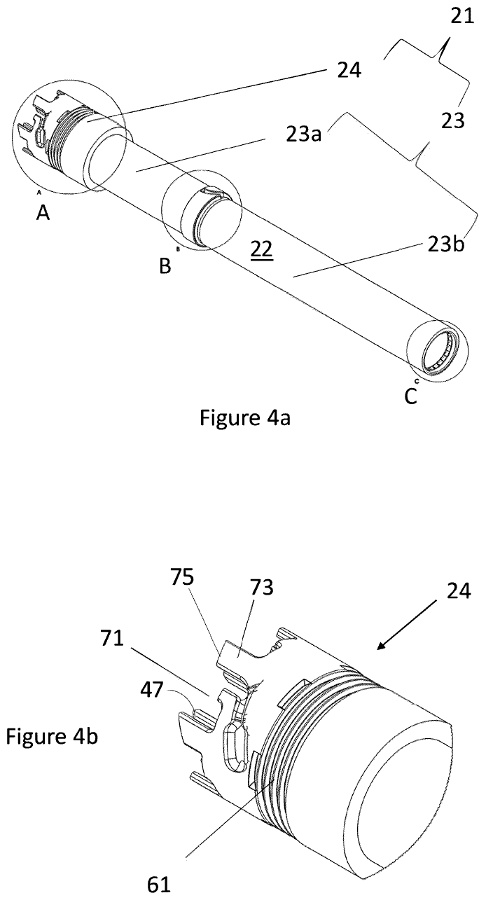

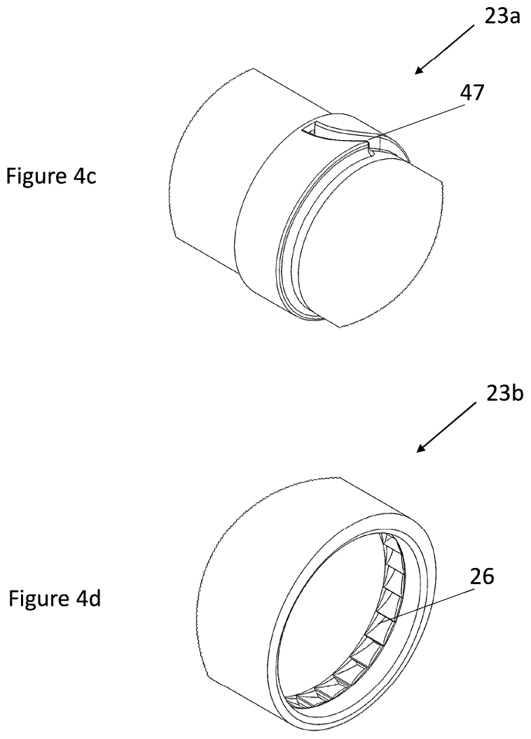

Explained in more detail below with reference to FIGS. 4a-4d, 6a-6b, 7a-7d and 8a-8b, each trigger assembly 7 is an assembly of the following components:
a. a detonation unit body generally identified by the numeral 21;
b. a retaining collar 25;
c. a trigger unit 17 in the form of the booster 19 and a detonator 15 and a trigger cord 31 (in the form of a nonel tube) that is connected at one end to the detonation unit body 21 and at the other end to the detonator 15;
d. a carrier cap 29 that supports the trigger unit 17; and
e. a connection unit 27 for connecting together the trigger cord 31 and the external activation system—either physically, i.e., by way of a detonation cord 13, or wirelessly.

The separate components that are assembled together to form the trigger assembly 7 may be made from any suitable material and by any suitable manufacturing method. By way of example, the components may be 3-D printed from a polymeric material.

Each trigger assembly 7 can be located at an open end of the hole 9 in an initial position of the trigger assembly in the hole 9. In this initial position the trigger assembly 7 is in an assembled form, with the detonation unit body 21 housing and supporting the trigger unit 17 and with the trigger cord 31 being at least partially wrapped or wound around the detonation unit body 21.

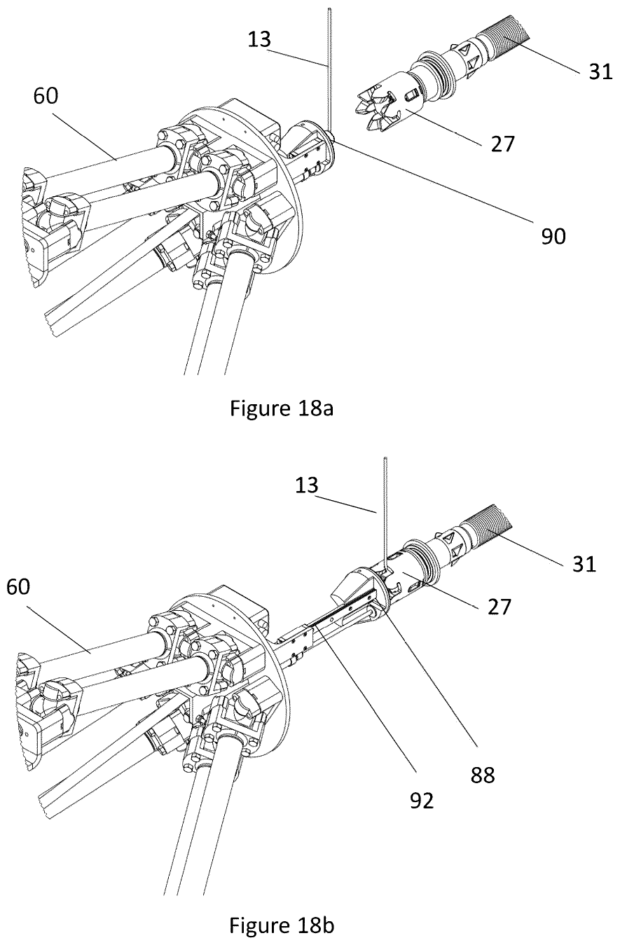

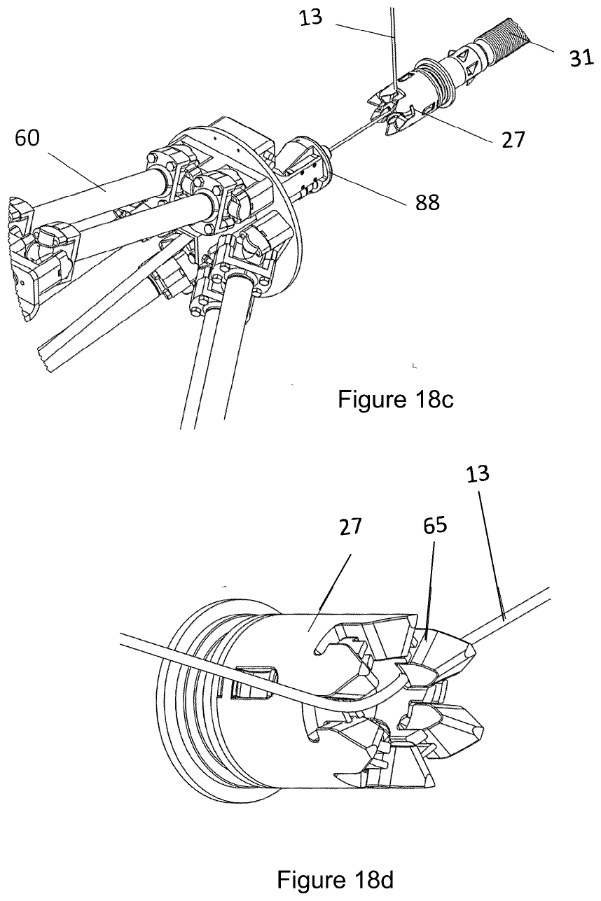

FIG. 18d shows in more detail than FIG. 1 the inter-connection of one trigger assembly 7 and the detonation cord 13 of the external activation means. As is described further below, the detonation cord 13 is positioned to extend across the trigger assembly 7 and is retained by the connection unit 27 in contact with the first end 31a of the trigger cord 31. Accordingly, in use, once the trigger unit 17 is at the detonation position, the activation means is actuated, triggering the explosive within the hole 9 and producing the explosive blast within the rock mass 11.

The term “open end” is understood in this context to mean the exposed end of the hole 9 that would typically be facing an operator when inserting the trigger assembly 7 therein.

### The Detonation Unit Body 21—FIGS. 1-10

The detonation unit body 21 will now be described in detail, with particular reference to FIGS. 4a to 4d.

The detonation unit body 21 is formed from three sections and includes a drum 24 (located at the proximal end thereof) and an elongate housing 23 (see FIG. 4a) that is configured to extend into the hole 9 and to receive and support the trigger unit 17 within a compartment 22 defined by the housing 23 in the initial position of the trigger assembly 7 in the hole 9. The trigger unit 17 is shown in the compartment 22 in FIG. 1b.

The housing 23 is a tubular housing, extending from a proximal end to a distal end. The tubular shape of the housing 23 facilitates easy insertion into the blast hole 9, for it approximates the shape of a conventionally drilled hole and does not require any specific or particular rotational orientating. It is understood, however, that other geometries are possible. In this description the term “proximal” end refers to the end that is closest to the operator, when the trigger assembly 7 is inserted into the hole 9. Put differently, the proximal end of the housing 23 is a near or forward end whilst the distal end of the housing 23 is a far or rearward end of the housing 23.

In the illustrated embodiments, the housing 23 is formed from two housing sections 23a, 23b that are joined together. The drum 24 is also joined to the first housing section 23a. The profile of these sections is best shown in FIGS. 4b to 4d. It is understood that this is but one way of forming the housing 23, and the housing 23 can, alternatively, be formed as a single piece.

The drum 24 of the detonation unit body 21 is shown in FIG. 4b and has a larger diameter than the housing 23. The drum 24 has a barrel-like shape and includes a plurality of open-ended slots 71 that extend axially along a length thereof. The slots are defined by posts 73. The upper ends of the posts 73 form ramps that are inclined axially from one side to the other side and serve as guides that aid the coupling of the connection unit 27 to the detonation unit body 21. The drum 24 also includes a plurality of circumferential grooves 61. The grooves 61 form part of a coupling mechanism that couples the connection unit 27 to the detonation unit body 21.

The housing sections 23a, 23b of the housing 23 are shown in FIGS. 4c and 4d respectively. These sections are tubular, and together provide the sleeve-like housing 23 around which the trigger cord 31 can be wound. The first section 23a may include features such as tabs configured to engage with the collar 25 to hold the collar 25 in place around the housing 23. Alternatively, the collar 25 may be a friction fit with the first section 23a. The second housing section 23b is open ended and serves as an end-piece within which the carrier cap 29 (see, for example, FIG. 1b) of the trigger unit 17 is received. An interior of the end of the second housing section 23b is lined with raised protrusions 26 that are configured to engage with the carrier cap 29 to hold it in via friction fit. Together, the two housing sections 23a, 23b define the compartment 22 within which the trigger unit 17 is received and accommodated.

Best shown in FIGS. 1a and 1b, the trigger cord 31 of the trigger unit 17 is connected at one end 31a to the detonator 15 of the trigger unit 17 and at the other end 31b to the proximal end of the detonation unit body 21, with the end 31b extending from the end. When the trigger assembly 7 is in the assembled form, the trigger cord 31 is wrapped in a spiral arrangement around at least a partial length of the detonation unit body 21. Specifically, in the illustrated embodiment, the trigger cord 31 is wrapped around the middle and rearward sections 23a, 23b of the housing 23.

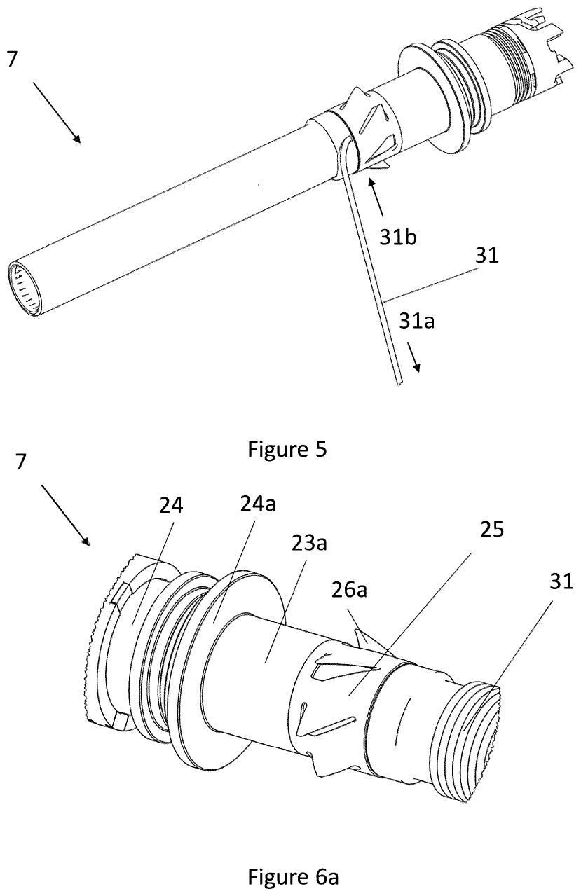

Turning now to FIG. 4c, the first housing section 23a includes an axially extending channel 47 that provides a passage for the trigger cord 31 to traverse past the collar 25—as shown in FIG. 5. In this way, the first end 31a of the trigger cord 31 is connected to the detonator 15 of the trigger unit 17 within the hole 9, whilst the second end 31b of the trigger cord 31 is exposed outside the hole 9, all the while with the trigger assembly 7 being retained within the hole via the collar 25.

It is understood, therefore, that the trigger cord 31 has a length that is a selected length to span the distance between the detonator 15 of the trigger unit 17 and the proximal end of the detonation unit body 21 when the trigger unit 17 is in the detonation position of the trigger assembly 7 in the hole 9, as shown in FIG. 1b. Accordingly, when the trigger unit 17 is at the detonation position, it remains operably connected to the proximal end of the detonation unit body 21.

### Retaining Collar 25—FIGS. 1-10

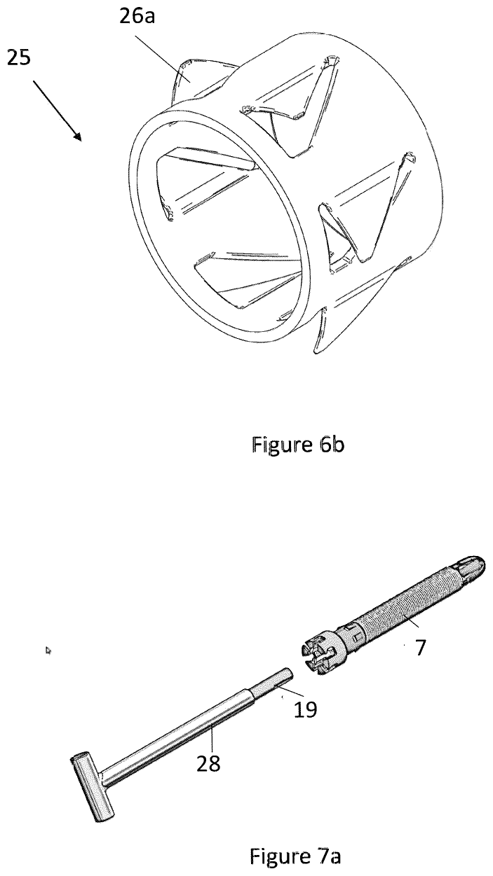

With reference to FIGS. 6a and 6b, the retaining collar 25 is disposed around the housing 23 of the detonation unit body 21 and can rotate about a central longitudinal axis of the housing 23 but is restrained from axial movement relative to the housing 23. Specifically, the collar 25 is rotationally coupled around housing 23.

The retaining collar 25 has two main functions.

The primary function is to contact the inner wall of the hole 9 to further limit insertion of the housing 23 into the hole 9. The collar 25 includes a plurality of projections in the form of flaps 26a for this function. The flaps 26 are disposed in a circular array around the outer surface of the retaining collar 25. The flaps 26a are designed to engage with the rock mass 11 of the inner wall of the hole 9 to axially retain the housing 23 in position, resisting forward and backward movement. Further, because the retaining collar 25 is rotationally coupled to the housing 23, the detonation unit body 21 is able to rotate whilst being axially held in position during deployment.

It is understood that the geometry of the flaps 26a in the illustrated embodiment is but an example of one configuration of retaining collar 25. Other geometries the provide analogous functionality are also possible and contemplated within the scope of this invention.

The secondary function is to limit insertion of the housing 23 of the trigger assembly 7 into the hole 9. The retaining collar 25 may include a circumferential flange for this function. It is noted, however, that this secondary function can also be provided by the detonation unit body 21 itself—i.e. by incorporating a flange into the detonation unit body 21 itself. In the illustrated embodiments, a flange 24a is incorporated into the drum 24.

### The Trigger Unit 17—FIGS. 1-10

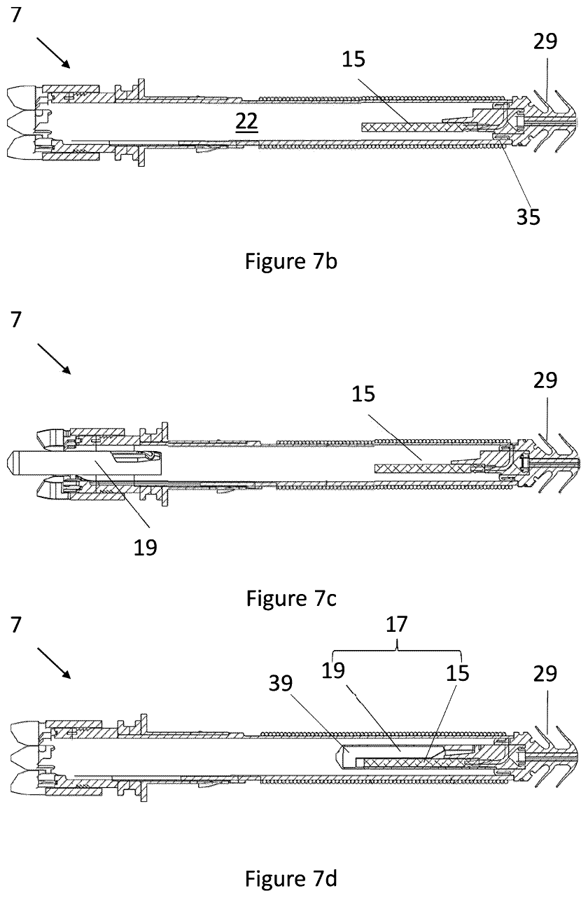

The trigger unit 17 will now be described in detail, with particular reference to FIGS. 7a to 7d.

In the embodiment shown in FIG. 7d, the detonator 15 of the trigger unit 17 is positioned ahead of the booster 19 within the housing 23 in the direction of insertion of the trigger assembly 7 into the hole 9. It is to be understood that the positions of the detonator 15 and the booster 19 can, alternatively, be reversed with the booster 19 being positioned ahead of the detonator 15.

The detonator 15 and the booster 19 are configured so that the detonator 15 can be received and housed within the booster 19. Specifically, the booster 19 includes an elongate chamber 39 (see FIGS. 7c and 7d) that is open at one end for receiving the detonator 15—with the detonator 15 being pre-fitted within the trigger assembly 7, being attached to the carrier 29. The booster 19 can be inserted into the housing 23 and moved forwards to envelop the detonator 15, which is pre-fitted within the trigger assembly 7. The insertion may be by way of a T-shaped pusher device 28, as shown in FIG. 7a. At this point, the detonator 15 is completely housed in the booster 19 and forms the trigger unit 17. In this way, the explosive (i.e. the booster 19) is kept separate from the detonator 15 and is only placed inside the trigger assembly 7 immediately before the trigger assembly 7 is to be used and inserted into the blast hole 9.

The detonation unit body 21 is configured to release the trigger unit 17 therefrom, where the trigger unit 17 comprising the booster 19 and the detonator 15 is separated from within the detonation unit body 21 and moved from the initial position in the hole 9 shown in FIG. 3a to an operative or detonation position in the hole 9 shown in FIG. 3b. As such, the trigger unit 17 is a detachable portion of the trigger assembly 7. In this separated form of the trigger assembly 7, the detonator unit body 21 serves as a fixed portion of the trigger assembly 7 that remains at the open end of the hole 9 whilst the detachable portion, the trigger unit 17, is located further into the hole 9 for detonating explosives in the hole 9 in the detonation position. The detonation position is typically at or proximate a closed end of the hole 9. What is meant by the term “closed end” is the far or terminal end of the hole 9.

The releasing of the trigger unit 17 from the detonation unit body 21 is facilitated by way of a frangible wall 35 that extends radially across the interior of the housing 23 towards a distal end thereof. The frangible wall 35 defines forward end of the compartment 22 and prevents forward movement of the trigger unit 17 into the hole 9. The frangible wall 35 is configured to detach or otherwise break when a force in excess of a threshold force is applied to the wall 35. With this arrangement, when the trigger unit 17 is held in the housing 23 in the initial position of the trigger assembly 7 in the hole 9, the wall 35 is a barrier to movement of the explosion trigger from within the compartment 22. Further forward movement of the trigger unit 17 to the detonation position requires breaking the frangible wall 35. The trigger assembly is thus moved forwardly from the initial position of the trigger assembly 7 in the hole 9 to the detonation position of the trigger assembly 7 in the hole 9 for example via application of an axial force.

### The Connection Unit 27—FIGS. 1-10

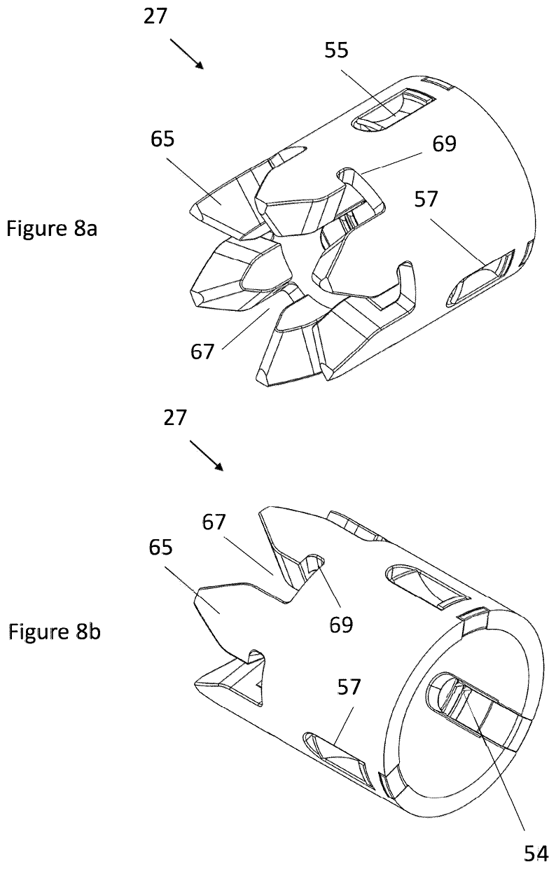

The connection unit 27 will now be described in detail, with particular reference to the embodiment shown in FIGS. 8a and 8b.

The connection unit 27 is a cylindrical sleeve that, in use, is coupled to a proximal end of the detonation unit body 21. In the illustrated embodiment, a distal end of the connection unit 27 has an internal diameter that is larger than a dimension of the proximal end of the housing 23 of the detonation unit body 21, enabling the connection unit 27 to fit as a cuff around the housing 23.

The distal end of the connection unit 27 includes engagement features for coupling with the proximal end of the detonation unit body 21. Best shown in FIG. 8b, the engagement features are provided as a plurality of tabs 55 that are pivotably attached to the sleeve within apertures 57 in the sleeve towards the distal end of the connection unit 27. In the illustrated embodiment there are three tabs 55, located within three corresponding apertures 57 equi-spaced around a perimeter of the sleeve of connection unit 27, however there could be more or less. The tabs 55 are removable, being pivotably mounted to the connection unit 27. This is beneficial, facilitating replacement of damaged and/or worn tabs 55 without requiring complete replacement of the connection unit 27.

Each tab 55 includes a pair of lips 54 that project inwardly with respect to the connection unit 27. The lips 54 are configured to engage within the circumferential grooves 61 that are disposed around the proximal end of the housing 23 of the detonation unit body 21 (shown in FIG. 4b). The lips 54 define a V shaped mouth that is oriented towards the proximal end of the connection unit 27. As such, the engagement between the tabs 55 and grooves 61 provides a ratchet-like one-way coupling between the connection unit 27 and the detonation unit body 21. In this manner, whilst the connection unit 27 can be brought into engagement with the detonation unit body 21 by sliding the distal end of the connection unit 27 over the proximal end of the housing 23 and sliding it axially there along, once the tabs 55 are engaged within the grooves 61, rearward axial movement is prevented.

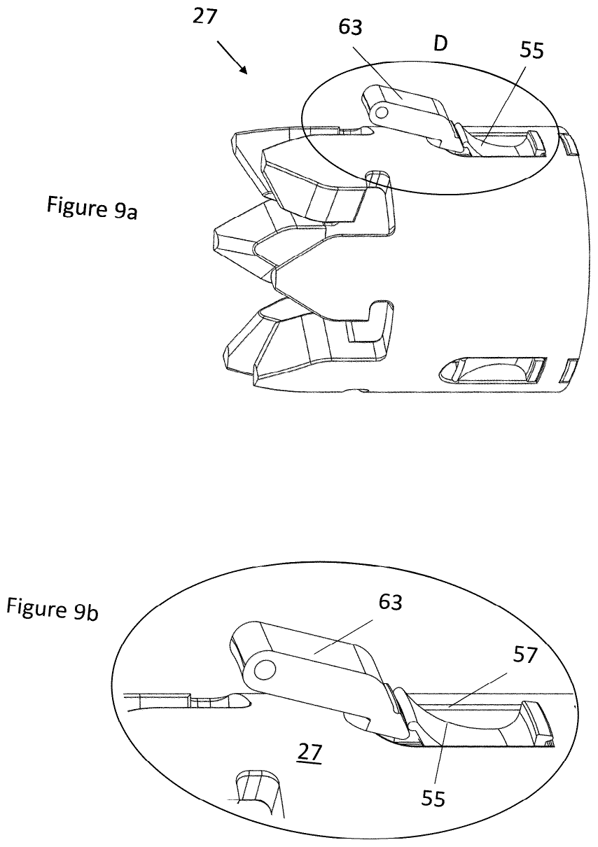

If required, however, the connection unit 27 can be disengaged from the detonation unit body 21 by inserting clip members 63 into the apertures 57. The clip members 63 have a complimentary profile to the tabs 55, and when inserted into the aperture 57, force the tab 55 to move outwardly with respect to the detonation unit body 21, such that the lips 54 disengage from the grooves 61. The clip members are shown in FIGS. 9a and 9b.

In other embodiments, not shown, the connection unit 27 may be coupled to the detonation unit body 21 by means other than the clip and groove connection which is described herein by way of a preferred example of a secure coupling.

Returning to FIGS. 8a and 8b, the connection unit 27 includes a plurality of projecting members 65 that extend from the proximal end of the connection unit 27. The projecting members 65 are configured to receive the detonation cord 13 of an external explosive activation system therebetween. The projecting members 65 each have a spade-like shape, tapering from a spike-like tip towards the base on each side thereof. The taper of the projecting members 65 guides the trigger cord 31 into a channel 67 between adjacent projecting members 65. The channels 67 provide a passage for the detonation cord 13 to travel through, radially across the connection unit 27. In the illustrated embodiment there are six projecting members 65, defining six channels 67 equi-spaced around a perimeter of the connection unit 27, however there could be more or less.

It is understood that in other embodiments the connection unit 27 may include other shapes of projecting members 65 and/or different forms of locating means for guiding the trigger cord 31 into position with respect thereto.

Each projecting member 65 also includes a notch 69, located towards a base thereof. The notch 69 is crescent shaped and configured to hold the trigger cord 31 captive therein.

Best shown in FIG. 4b, the proximal end of the detonation unit body 21—i.e. the drum 24—includes the aforementioned plurality of open-ended slots 71 that extend axially from the proximal end thereof, with each slot 71 being defined on either side by two concentric rows of upstanding posts 73. A trough or channel 47 extends circumferentially around the proximal end of the housing 23, between the concentric rows of posts 73. The channel 47 provides a passage around which the second end 31b of the trigger cord is wrapped, such that the trigger cord 31 extends around a complete perimeter of the proximal end of the housing 23. This wrapped section of the trigger cord 31 is positioned to contact the detonation cord 13.

The slots 71 each have a complimentary profile to that of the projecting members 65, so as to bias together therewith and guide the connection unit 27 into a coupled arrangement with the detonation unit body 21. Specifically, as noted above, the end of each post 73 is formed as an inclined ramp 75 that provides a cam surface along which a base of the projection members 65 travels when the connection unit 27 is moved from an inoperative position to an operative position. The ramp 75 defines a helix like path that guides the projecting members 65 into axial and rotational alignment with the respective slots 71.

In other embodiments, where the connection between the trigger assembly 7 and the external detonation means is not a physical connection, the connection unit 27 instead can include a wireless receiver. The wireless receiver may be positioned such that when the connection unit 27 is coupled to the detonation unit body 21, the wireless receiver is operatively coupled to trigger unit 17 via the trigger cord 31 providing a functional equivalent to the connection between the detonation cord 13 and the trigger cord 31 as previously described.

### Coupling the Connection Unit 27 to the Detonation Unit Body 21—FIGS. 1-10

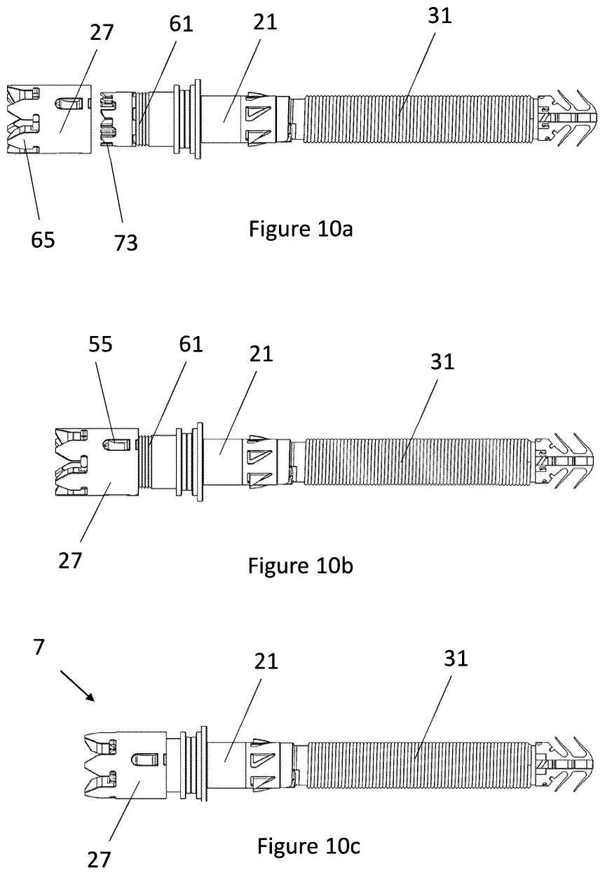

With reference to FIGS. 10a to 10c, a method of coupling together the connection unit 27 with the detonation unit body 21 is described below.

In a first coupling step, the connection unit 27, which at this stage is a separate component from the detonation unit body 21 (see FIG. 10a), is coupled together in a first inoperative position with a proximal end of the detonation unit body 21. In this first inoperative position, the tabs 55 of the connection unit 27 are engaged within a first row of grooves 61 of the detonation unit body 21. The first, inoperative position of the connection unit 27 is shown in FIG. 10b. In a second coupling step, the connection unit 27 is then moved axially along the detonation unit body 21 to a second operative position. In the second operative position, the tabs 55 are engaged with a subsequent row of grooves 61, the subsequent row of grooves 61 being distal of the first row. The second, operative position of the connection unit 27 is shown in FIG. 10c. In both positions, the connection unit 27 is coupled to the detonation unit body 21, thus enabling the trigger assembly 7 (including both the detonation unit body 21 and the connection unit 27) to be handled and moved together, as an integrated unit.

With the connection unit 27 in the second operative position, each of the projecting members 65 is in abutment with one of the posts 73. In this position, each notch 69 and associated post 73 form an opening within which the detonation cord 13 is held captive, the opening being in communication with the trough 79. In this way, when the detonation cord 31 is captured within the notch 69 of the connection unit 27 and the connection unit 27 is in the second coupled position with respect to the detonation unit body 21, the detonation cord 13 is physically connected to the trigger cord 31. This interconnection is best captured by FIG. 18d, which is described in more detail later.

Furthermore, should it be necessary to connect the trigger unit 17 with a subsequent trigger unit 17, a free end of the detonation cord 13 can be fed though a gap 67 of the connection unit 27 towards a second or further connection unit 27′ of the subsequent trigger unit 17′. The detonation cord 13 can then be received by the connection unit 27′ and the coupling steps repeated, thereby operably tying together the trigger units 17 in the heading 11.

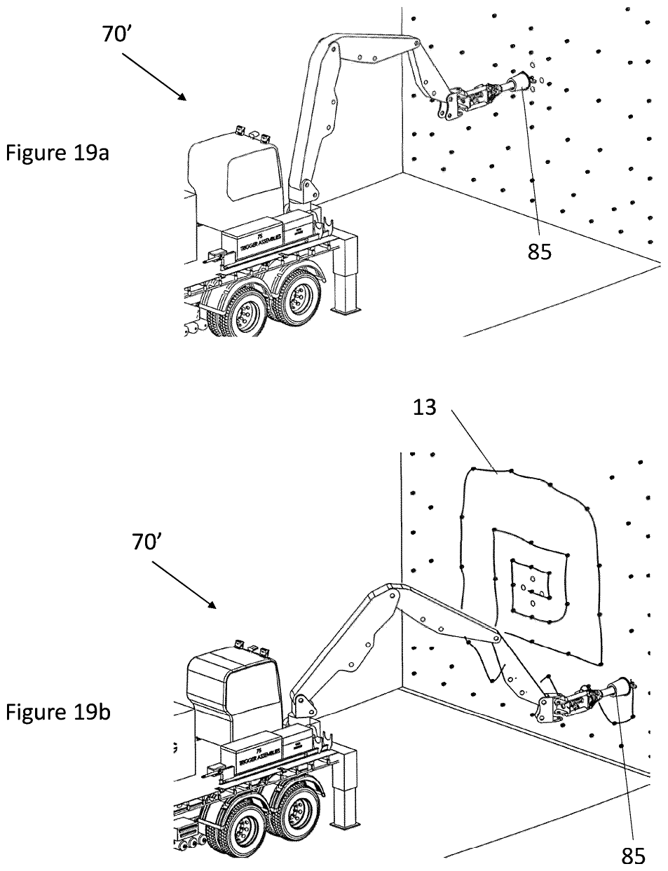

Accordingly, an explosive blast in the hole 9 can thus be initiated in a subsequent step by triggering the booster 19 of the respective trigger unit or units 17 with the activation means, the activation means being operably connected to the booster 19 via the detonation cord 13 and trigger cord 31. This interconnection is best captured by FIG. 19b, which is described in more detail later.

Furthermore, should the connection unit 27 be wirelessly connected to the external activation means, the first coupling step may be all that is required to operably connect the external activation means to the trigger unit 17 of the trigger assembly 7. The two-step coupling movement—that is from a first inoperative position to a second operative position—is still useful in such an embodiment, for it enables the wireless connection unit 27 to be fitted to the trigger assembly 7 for handling/loading, prior to being “activated”.

### Assembling the Trigger Assembly 7—FIGS. 1-10

Summarily, the trigger assembly 7 is assembled in a multi-step process. Some or all of these steps can take place off-site (i.e., before the trigger assemblies are loaded onto the vehicle and transported to the working site).

The broad stages are as follows:
Attach one end of the trigger cord 31 to the connection unit 27.
Position the detonator 15 in the carrier cap 29.
Wind the trigger cord 31 onto housing 23.
Position the connection unit 27 into the initial position with respect to the housing 23.
Internal ratchet the carrier cap 29 into the end of the housing 23 so that the detonator 15 is within the housing 23.

### Mechanisation of the Blasting Process—FIGS. 1-10

Whilst the trigger assembly 7 can be inserted into a blast hole 9 manually by an operator, that is by hand, the design of the trigger assembly 7, in particular that of the connection unit 27 has been driven with mechanisation in mind.

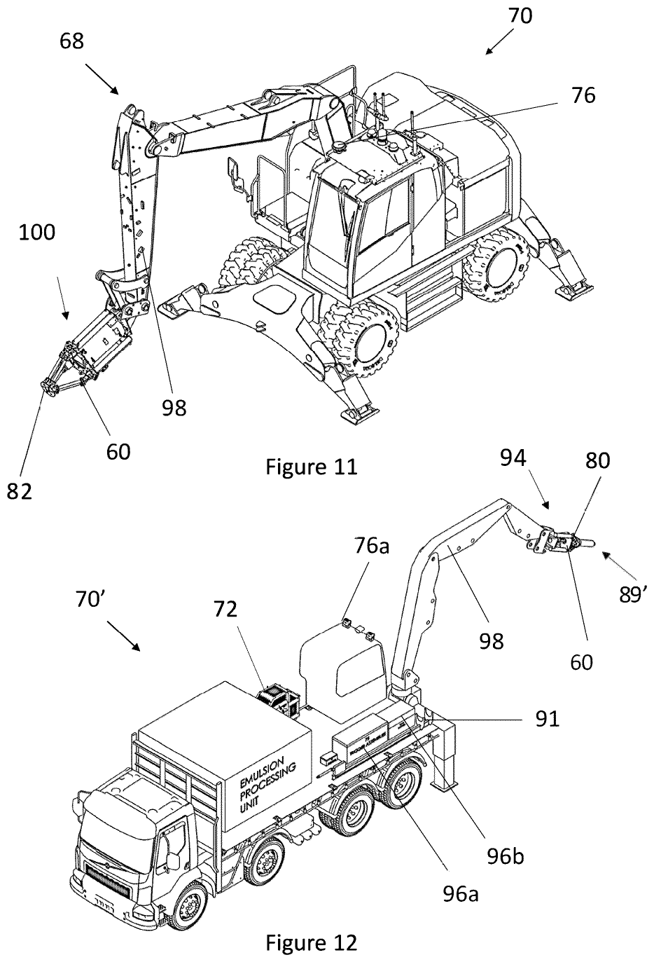

With reference to FIGS. 11 to 18, it is contemplated that the trigger assembly 7 be inserted into the blast hole 9 using at least one vehicle 70 that is equipped with at least one functional unit 89 that is specially adapted to do this.

The vehicle(s) 70 may be a purpose-built vehicle(s), or, alternatively, the vehicle(s) 70 may be a modified standard mining vehicle(s) such as, for example, a mining jumbo.

Embodiments of the trigger assembly 7 are shown in FIGS. 20-26

The following description highlights the main differences between the embodiments of the trigger assembly 7 shown in FIGS. 1-10 and FIGS. 20-26, with the same reference numerals being used to describe the same structural features, using the same headings used above.

One of the main differences between the two embodiments is that the trigger cord 31 of the trigger assembly of the FIGS. 20-26 embodiment is at least substantially located outside the hole 9 when the trigger assembly 7 is first located in the hole 9, i.e., in the initial position of the trigger assembly 7 in the hole 9—see FIG. 26. This is a quite different arrangement to that of the FIGS. 1-10 embodiment. This feature means that there are fewer components of the trigger assembly 7 in the hole 9 and this simplifies manufacture of the trigger assembly. In addition, locating the trigger cord 31 outside the hole 9 means that, in use, the trigger cord 31 unwinds as a straighter length than is the case with the FIGS. 1-10 embodiment. Specifically, the trigger cord 31 unwinds in a spiral motion and enters the hole as a straight length as an emulsion hose pushes the trigger unit 17 into the hole 9 rather than as a helix motion as is the case with the FIGS. 1-10 embodiment. This is an advantage in terms of minimising risk of fouling of the trigger cord 31 as it unwinds.

Another main difference between the two embodiments is the structure of the connection unit 27. In the FIGS. 20-26 embodiment, the connection unit 27 is a resilient element that receives and connects the detonation cord 13 of an external explosive activation system (not shown) to the trigger cord 31. This is a quite different arrangement to that of the FIGS. 1-10 embodiment which relies on the connection unit 27 part being configured to respond to axially forward rotational movement about an axis of the trigger assembly 7 from an initial position to a locked position. It is noted that the reference to “resilient element” does not mean that the whole connection unit is formed from a resilient material, although this may be the case. The term is intended to focus on the operative parts of the resilient element that are involved in connecting the detonation cord 13 to the trigger cord 31.

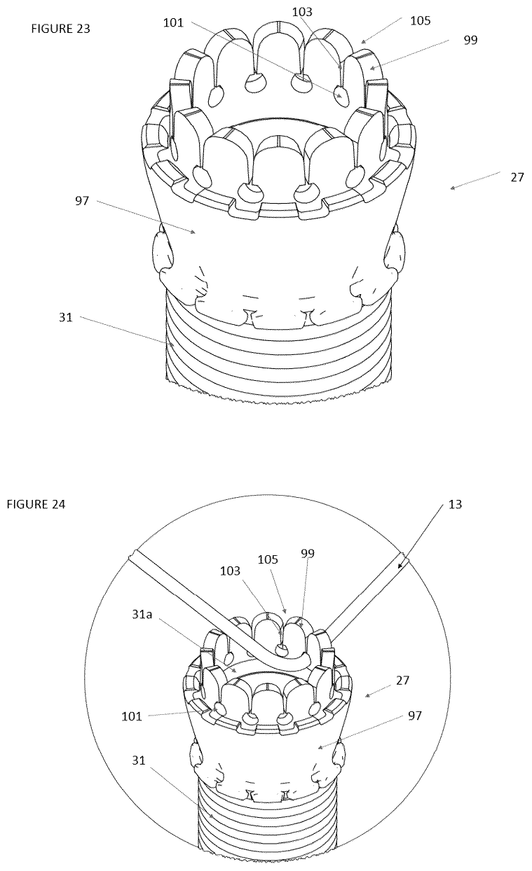

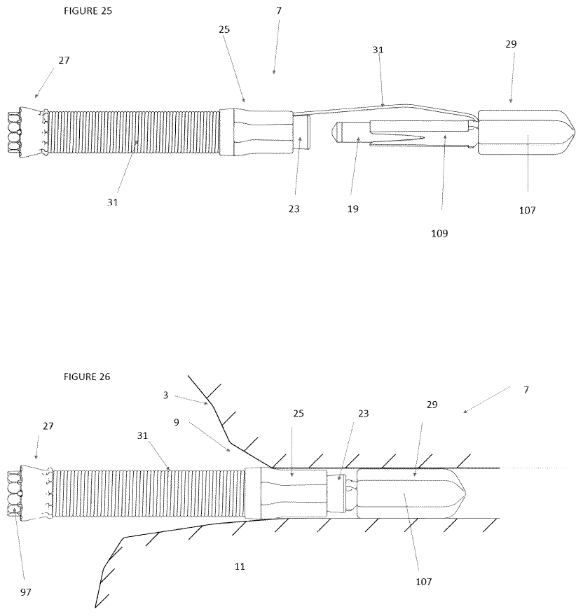

As can best be seen in FIGS. 23 and 24, the connection unit 27 is generally crown-shaped and comprises a tubular body 97 that engages the first housing section 23a and a circular array of arms 99 that are spaced around a proximate end of the body 97. Successive arms 99 define a generally key-hole shaped passage with two opposed open sides and two opposed closed sides (with the open sides allowing a section of the detonation cord 13 to be positioned to extend from one side to the other side across the passage), with the passage having a circular base section 101 for receiving and connecting the detonation cord 13 to the first end of the trigger cord 31a (see FIG. 24) retained by the connection unit 27 (described further below) and a narrower width elongate throat section 103 that communicates at one end with the circular base section 101 and has an opening 105 at the other end through such that, in use, the detonation cord 13 can be moved into the throat section 103 and along the throat section to the circular base section 101 and contact the first end of the trigger cord 31a. FIG. 24 shows the detonation cord 13 in place in one circular base section 101 and being moved to be inserted into an opposed circular base section 101. The arms 99 are resilient arms such that inserting the detonation cord 13 into the opening 105 and moving the detonation cord 13 through the throat section 103 to the circular base section 101 forces the arms apart from an original position against the resilience of the arms, with the arms 99 returning to the original position after the detonation cord 31 is in the circular base section 101, with the returned arms in the original position resisting release of the detonation cord 31 from the circular base section 101 and contributing to retaining the detonation cord 13 in contact with the first end of the trigger cord 31a. It can be appreciated that the detonation cord 13 can be released from the circular base section 101 by applying sufficient force to overcome the resilience of the arms 99 and allow the detonation cord 13 to be removed via the throat 103.

Another main difference is the structure of the detonation unit body 21 and the retaining collar 25. This is in part due to the above differences.

The detonation unit body 21 includes an elongate housing 23 (see FIG. 22) that is configured to support the connection unit 27 at the proximal end and to receive and support the trigger unit 17 at the distal end within a compartment 22 defined by the housing 23 in the initial position of the trigger assembly 7 in the hole 9. The trigger unit 17 is shown in the compartment 22 in FIG. 22.

The retaining collar 25 is disposed around the housing 23 of the detonation unit body 21 and is configured to engage a section of an internal wall of the hole 9 to prevent axial movement relative to the housing 23 and is also configured to allow the detonation unit body 21 to rotate about a central longitudinal axis of the housing 23.

The elongate housing 23 is a tubular housing, extending from the proximal end to the distal end. The tubular shape of the housing 23 facilitates easy insertion into the hole 9, for it approximates the shape of a conventionally drilled hole and does not require any specific or particular rotational orientation. It is understood, however, that other geometries are possible.

In this description the term “proximal” end refers to the end that is closest to the operator, when the trigger assembly 7 is inserted into the hole 11. Put differently, the proximal end of the housing 23 is a near or forward end whilst the distal end of the housing 23 is a far or rearward end of the housing 23.

The housing 23 is formed from two housing sections 23a, 23b that are joined together. The profile of these sections is best shown in FIGS. 22 and 22a. It is understood that this is but one way of forming the housing 23, and the housing 23 can, alternatively, be formed as a single piece.

The housing sections 23a, 23b of the housing 23 are tubular.

The first housing section 23a provides a sleeve-like housing 23 around which the trigger cord 31 can be wound. As noted above, unlike the embodiment shown in FIGS. 1-10, the trigger assembly shown in FIGS. 20-26 is formed so that in use, the first housing section 23a and the trigger cord 31 wrapped around the first housing section 23a are outside the hole 9.

The second housing section 23b is open ended and serves as an end-piece within which the carrier cap 29 (see, for example, FIG. 20) of the trigger assembly 7 is received. An interior of the end of the second housing section 23b is lined with raised protrusions 26 that are configured to engage with the carrier cap 29 to hold it in via friction fit.

Together, the housing sections 23a, 23b define the compartment 22 within which the trigger unit 17 is received and accommodated.

In addition, the housing sections 23a, 23b may include features such as tabs (not shown) configured to engage with the retaining collar 25 to hold the collar 25 in place around the housing 23.

As can best be seen in FIGS. 24 and 25, the trigger cord 31 of the trigger unit 17 is connected at one end 31a to the detonator 15 of the trigger unit 17 (FIG. 25) and at the other end 31b to the proximal end of the detonation unit body 21 (FIG. 24).

Turning now to FIGS. 22 and 22a, the housing sections 23a and 23b include axially extending channels (not shown but can be envisioned from the Figures) that provide a passage for the trigger cord 31 to traverse underneath the retaining collar 25. In addition, the first housing section 23a includes an axially extending channel (not shown) that provides a passage for the trigger cord 31 to traverse underneath the connection unit 27.

In this way, the first end 31a of the trigger cord 31 is connected to the detonator 15 of the trigger unit 17 within the hole 9, whilst the second end 31b of the trigger cord 31 is exposed outside the hole 9 and retained in position by the connection unit 27, all the while with the trigger assembly 7 being retained within the hole 9 via the collar 25.

It is understood that the trigger cord 31 has a selected length to span the distance between the detonator 15 of the trigger unit 17 and the proximal end of the detonation unit body 21 when the trigger unit 17 is in the detonation position of the trigger assembly 7 in the hole 9. Accordingly, when the trigger unit 17 is at the detonation position, it remains operably connected to the proximal end of the detonation unit body 21.

The trigger unit 17 and the carrier cap 29 of the FIGS. 20-26 embodiment are basically the same as the FIGS. 1-10 embodiment. The trigger unit 17 comprises a detonator 15 and a booster 19 that are configured so that the detonator 15 can be received and housed within the booster 19. The carrier cap 29 includes a body 107 with a tapered forward end, and a sleeve 109 for receiving and retaining the trigger unit 17.

The trigger assembly 7 of the FIGS. 20-26 embodiment is configured to be used generally as described above in relation to the FIGS. 1-10 embodiment.

### The Vehicles

The embodiment described in relation to the Figures includes two vehicles, one optimised for hole and heading cleaning and the other optimised for trigger assembly and emulsion delivery and detonation cord tie-in.

The first vehicle 70 shown in FIG. 11 is an embodiment of a “face inspection vehicle” that is configured to prepare a hole 9 for receiving the trigger assembly 7. The face inspection vehicle 70 is a specialised mining vehicle that is designed to undertake preparations including cleaning and/or otherwise inspecting the blast hole 9 and/or the heading 11 surrounding the hole 9.

The second vehicle 70′ shown in FIG. 12, on the other hand, is an embodiment of a “delivery vehicle” or “explosives charging and detonation cord tie-in vehicle” that is configured to (i) prepare and locate a trigger assembly 7 within a blast hole 9, (ii) pump or otherwise deliver the explosive into the blast hole 9 for triggering via the trigger assembly 7, and (iii) tie-in together all of the trigger assemblies 7 of an external explosive activation system (not shown). With reference to step (iii) this tie in may be a physical tie in via the detonation cord 14 (as shown in the illustrated embodiments) or, alternatively, may be a wireless via connection units equipped with wireless receivers.

Each vehicle 70, 70′ may have a cabin for an operator to carry out the face inspection, trigger assembly location, explosives charging, and detonation cord tie-in functions. Alternatively, it is also contemplated that the vehicles 70, 70′ may be autonomous or semi-autonomous (i.e., remote-controlled) vehicles that do not require a cabin.

The invention is not confined to the use of two vehicles 70, 70′ and other possible embodiments are single vehicle embodiments carrying all the required functional units 89 100 in any given situation.

Specifically, the functions of both the “face inspection vehicle” and the ‘explosives charging vehicle’ may be undertaken by a single, combined multi-purpose mining vehicle. This multi-purpose vehicle is not shown in the Figures.

In addition, there may be situations where the first vehicle 70 is not required. For example, there may be situations in which the functions of the “face inspection vehicle” are not required or are carried out via another option.

### The First Vehicle

An embodiment of the first vehicle 70 is a Robotic Excavator (REX)—see FIG. 11.

The first vehicle 70 is a specialised mining vehicle configured to clean holes to remove blockages and debris and to clean the face and floor of a heading 11 by removing loose cuttings from the heading 11 and pulling back cuttings from the heading—this is a baseline quality issue.

The first vehicle 70 is configured to support and operate functional units 89 (described further below) that are configured to carry out the above hole cleaning and debris removal functions.

The first vehicle 70 shown in FIG. 11 has an articulated arm 98 that is capable of movement up/down, forward/rearward, side-to-side, and a fine positioning module 100 on a forward end of the arm 98, which is mounted to rotate about an axis. The arm 98 serves as a coarse positioning module 68 of the vehicle 70.

Together, the coarse positioning module 68 and the fine positioning module 100 form part of a positioning unit 94 of the vehicle 70.

The coarse positioning module 68 is configured to position a functional unit 89′ (described below and shown in FIG. 12) proximate a hole 9 in the end face 3. The fine positioning module 100 is configured to locate and align the functional unit 89′ more accurately in relation to the hole 9.

The positioning unit of the first vehicle 70 (and the second vehicle 70′) also includes a control system (not shown) that can track a hole 9, for example by video servo methods or similar hole monitoring options, and operate the fine positioning module 100 to adjust, typically continuously, the position of the functional unit 89′ (and any other selected functional unit). This feature enables (once in position) the fine positioning module 100 to “float” in the “correct” position if the vehicle 70 moves for any reason and keep the functional unit 89′ aligned with the hole 9.

The positioning unit of the first vehicle 70—see FIG. 11—(and the second vehicle 70′) also includes a vision module comprising:
a vision-based system 76 on the vehicle to monitor the position of the coarse positioning module 68 in relation to a hole 9 to facilitate guiding the functional unit 98′ to a required location in relation to the hole 9; and
a second vision-based system 80 on the end of the fine positioning module 100 to monitor the position of the fine positioning module 100 in relation to the hole 9 to facilitate guiding the functional unit 98′ to a required location in relation to the hole 9.

By way of example, the first vehicle 70 may have a +−50 mm cartesian-based X, Y, Z vision system 76—this can facilitate coarse positioning the functional unit 98′ to be within 100-200 mm of a hole centre.

Typically, the vision-based system 76 on the first vehicle 70 sees the full heading (lighting provided by the vehicle 70).

The vision-based system 76 on the first vehicle 70 builds a “live” image of the heading 11 (or part of the heading 11) that includes the topology of the heading 11.

The vision-based system 76 on the first vehicle 70 presents the image on a “touch screen” and is configured to allow an operator to point to the location of the hole 9 on the touch screen and to actuate movement of the vehicle arm 98 to coarsely align the functional unit 89′ on the end of the arm 98 with the hole 9—i.e. positioning to within 100-200 mm of the hole centre.

As noted above, the fine positioning module 100 then locates and/or aligns the functional unit 98′ more accurately in relation to the hole 9.

In the illustrated examples, the fine positioning module 100 includes a delta positioning system robotic unit 74, noting that invention is not confined to the use of delta positioning systems.

The delta positioning system includes a hydraulic system to move the adjustment arms of the delta system. The invention is not confined to the use of hydraulics.

The delta system unit operates with 3 degrees of freedom—up, down, and forward/back.

Other embodiments operate with 6 degrees of freedom—pitch, roll and yaw—in addition to the above-mentioned 3 degrees of freedom.

The delta system unit incorporates a video-based vision system that uses deep learning technology using AI technology, looking for patterns in images. The applicant adapted an open-source training package for use in underground block cave mine applications.

The delta system unit is preferably driven by servo motors and/or controllers. In use, the video-based vision system enables the delta system unit to track the hole 9 by video servo methods or similar hole monitoring and feedback techniques and continuously correct the position accordingly. This enables the fine positioning module 100 to “float” in the correct position (i.e. in alignment with the hole) if the vehicle (or coarse positioning arm) is accidently moved. This is particularly useful in unstable terrain where the vehicle 70,70′ and the coarse positioning arm may be subject to fluctuations in position.

An alternative to using the video-based vision system to detect holes is to use drill data log. This data is generated during drilling holes. It provides accurate information on the location of holes. There is an opportunity to use the information to allow fine positioning—rather than detecting the holes, the vision system is merely checking and verifying that the holes are in the expected location.

Cleaning holes 9 is very important to ensure that there are no blockages in holes 9 or to identify blockages and select emulsion explosive volumes for the holes 9.

A currently preferred unblocking system is an air/water nozzle—rearwardly-directed nozzle. Use air first, if blockage, flood with water, air again to pull out debris.

### The Second Vehicle

The second vehicle 70′ shown in FIG. 12 is similar to the first vehicle 70 in that it has an articulated arm 98 and a fine positioning module 100 on an end of the arm 98, with the vehicle 70′ having the above-described vision-based positioning system for monitoring movement of the coarse positioning module 68 in relation to the hole 9 and a delta positioning system unit 80 on the end of the arm 98 for further monitoring movement of the fine positioning module 100 into closer alignment with the hole 9.

The second vehicle 70′ also includes:
(a) an emulsion explosive processing unit and hose reel 72,
(b) a trigger assembly storage unit 96a storing multiple trigger assemblies 7 (without boosters 19)—typically, the number of trigger assemblies 7 required for a given heading 11,
(c) a booster storage unit 96b storing multiple boosters 19—typically, the number of boosters 19 required for the heading 11, and
(d) a detonation cord tie-in module storage unit for housing a tie-in module 85 having sufficient length of detonation cord 13 to tie-in the trigger assemblies 7 in the heading 11.

The second vehicle 70′ is configured to carry out the following functions:
(a) locating trigger assemblies 7 in holes 9;
(b) filling holes with emulsion explosive; and
(c) tying-in the holes 9 with a detonation cord 13 or any other suitable detonation system, such as any other cord—see triggering assembly portfolio. Also note, could use wireless and therefore no need tie-in.

The above process will now be described in broad terms, noting that further detail is provided later.

The procedure to locate a trigger assembly 7 (with a booster 19) in a hole 9 includes a first^{t} step of an operator manually removing a booster 19 and a trigger assembly 7 from their separate storage compartments 96a, 96b and inserting the booster 19 into the trigger assembly 7 using a T shaped pusher tool 28 as shown in FIG. 7a. It is noted that this step may be an automated step.

The process of assembling the trigger assembly 7 is preferably assisted via a hand-off unit of the vehicle 70.

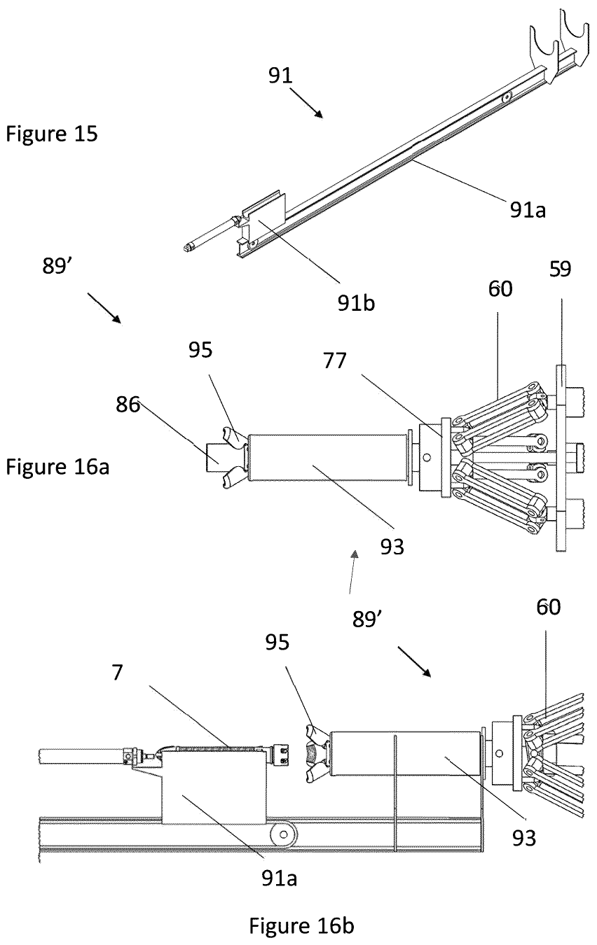

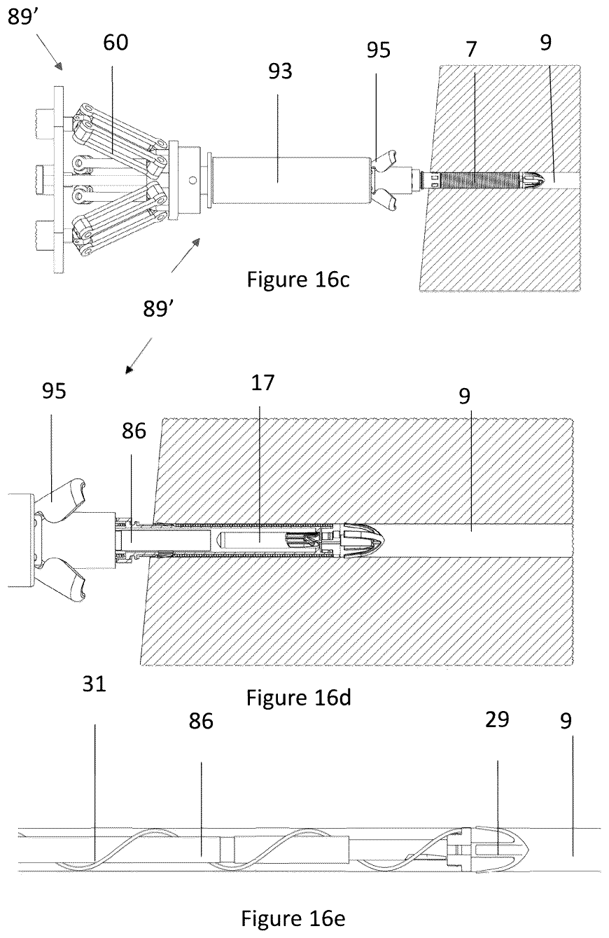

Shown in FIG. 15, the hand-off unit 91 includes a slider 91a which provides a support in the form of a carriage for the assembled trigger assembly 7. Once the booster 19 has been inserted into the detonation unit body 21, the carriage can be actuated to move the assembled trigger assembly 7 from an initial, assembly position to an operative “hand-off” position where the trigger assembly 7 can be picked up by the functional unit 89′ (FIGS. 16a-16d).

Best shown in FIG. 16a, one such functional unit 89′ includes (a) a housing 93 for protecting the trigger assembly 7 (with booster 19) in use of the functional unit 89′ to position the trigger assembly 7 (with booster 19) in the drilled hole 9 and (b) a gripper unit 95 positioned at an opening of the housing 93, with the gripper unit 95 being movable between closed and open positions to allow insertion of the trigger assembly 7 into the housing 93.

Referring to FIG. 16b, the functional unit 89′ is moved—via the positioning unit 94 of the vehicle 70′—to a pick-up position adjacent to the slider 91. The gripper 95 is opened, and the slider 91 is then activated once more, such that the assembled trigger assembly 7 is inserted into the housing 93 and the gripper unit 95 moved to a closed position. It can be appreciated that, when in the closed position, the functional unit 89′ holds the assembled trigger assembly 7 safely and securely during movement to an aligned position in relation to the hole 9.

In other embodiments the hand-off unit 91 may incorporate a magazine type structure, capable of sequentially holding several trigger assemblies 7 and/or trigger units 17 at the same time.

As illustrated, the positioning unit 94 includes the articulated arm 98 that forms part of the coarse positioning module 68, but it is understood other arrangements are possible.

With the assembled trigger assembly 7 located in the housing 93 of the functional unit 89′, the articulated arm 98 then moves from the loading position proximate the second vehicle 70′ to an unloading position in which the assembled trigger assembly 7 is located proximate the end face 3. This is shown in FIG. 16c. This movement is understood to be a positioning movement of the coarse positioning module 68. Once this initial positioning movement is completed, the fine positioning module 100 of the positioning unit 94 operates to align the functional unit 89′ with the hole 9 and the positioning unit 94, i.e. the coarse 68 and fine positioning modules, 100 is “parked”.

The assembled trigger assembly 7 is then inserted into the hole 9 using a pusher mechanism of the functional unit 89′ (shown in FIG. 16d). Together, the fine 100 and coarse positioning modules 68, form the positioning unit 94 of the second vehicle 70′.

In the unloading position, after the insertion of the assembled trigger assembly 7, the emulsion explosive processing unit and hose reel 72 deliver emulsion explosives to the hole 9 and the emulsion hose 86 moves the trigger unit 17 (with detonator 15 and booster 19) from the trigger assembly 7 to a required location in the hole 9 (shown in FIG. 16e). Emulsion explosive is injected into the hole 9 as the hose 86 is retracted from the hole 9.

Once all trigger assemblies 7 are located within the holes 9 and in the detonation position, another functional unit 89″ (or, alternatively, a combined functional unit 89, 89′ having the same functions as the gripper 95), in the form of the tie-in module 85 is configured to connect the trigger cords 31 of the of the respective trigger assemblies 7 to the external activation means. In the case of a physical connection, the tie-in module 85 is moved to successive tie-in positions in which the tie-in module is aligned with a trigger assembly 7 in a first hole 9 and ties-in the nonel cord 13 of that trigger assembly 7 and moves to successive trigger assemblies 7′ and repeats the tie-in step. This step is best shown in FIGS. 18a and 18d and is described in more detail later.

Various aspects of this process will now be described in more detail below.

### The Positioning Unit

Each vehicle 70 includes a positioning unit 94. The positioning unit 94 is configured to move and locate a functional unit 89′ with respect to a working position, to allow the functional unit 89′ to carry out required functions at, for example, the heading 11 or in relation to the holes 9. It is noted that the functional unit 89′ itself may be independently moveable with respect to the positioning unit 94—thus providing a third “level” or step of movement.

The positioning unit 94 comprises a coarse positioning module 68 and a fine positioning module 100.

The different positioning modules 100, 68 are associated with different levels of applied force and torque, and range and resolution/accuracy. Specifically, the coarse positioning module 68 is designed for broad/heavy, “positioning” movements, whilst the fine positioning module 100 is designed for light/soft “locating” or “aligning” motions. As such, the dexterity of the combined positioning unit 94 is increased—locating tasks retain the precision of the fine positioning module 100 while larger movements are handled by the coarse positioning module 68.

The coarse positioning module 68 is configured to position the functional unit 89′ proximate to the blast hole 9. In this sense, the term “proximate” means a rough or approximate positioning of the functional unit 89′. The coarse positioning module 68 has an articulated arm 98. In some embodiments, the coarse positioning module 68 is an articulated arm or boom of a jumbo or other conventional mining vehicle.

The fine positioning module 100 is configured to adjust the position of the functional unit 89′ relative to the end face 3 whilst the coarse positioning module 68 remains stationary or “parked”. Specifically, such adjustment includes locating and aligning a functional unit 89′ with respect to the blast hole 9. Furthermore, the fine movement module 100 is configured to maintain “floating” alignment with the hole 9 in the event that the vehicle 70,70′ and/or the coarse positioning module 68 moves or drifts from position.

In order to achieve the “floating” arrangement, the positioning unit 94 includes a control system that can track the hole 9, for example by video servo methods or similar hole monitoring options, and operate the fine positioning module 100 to adjust, typically continuously, the position of the functional unit 89′.

The fine positioning module 100 comprises a plurality of elongate arms or links 60 that are pivotably attached at one end to a base (i.e. hub) 59, with each link 60 being coupled together at a central hub or travelling platform 77, to which the functional unit 89′ is couplable. In the embodiment shown in the Figures, the fine positioning module 100 includes a delta robot. Each of the elongate links 60 is independently moveable, with relative movement between the links 60 resulting in movement of the platform 77. The fine positioning module 100 is best shown in FIGS. 16 and 18.

The travelling platform 77 is capable of both translational and rotational movement, to align and locate the functional unit 89′ with respect to the hole 9. The travelling platform 77 includes a central aperture 78. The central aperture 78 provides a passage through which elements or parts of the functional units 89′ can be extended and passed. In use, the central aperture 78 is aligned co-axially with the hole 9.

The base 59 of the fine positioning module 100 is directly coupled with the coarse positioning module 68. In this way, movement of the coarse positioning module 68 results in movement of the fine positioning module 100. This enables the fine positioning module 100 to have a reduced total range of motion, enabling for increased resolution in movement and control. This increased resolution enables the fine positioning module 100 to provide adjustment of the position of the functional unit 89′ coupled thereto, whilst the coarse movement module 68 remains stationery or otherwise parked—such that the only applied forces and/or torques being exerted are those of the fine positioning module 100. It is to be understood, therefore, that the fine 100 and coarse positioning modules 68 work together to position the functional unit 89′ with respect to the hole 9.

The vision modules 76, 80 is used to monitor and guide movements of the respective positioning modules 100, 68. Each vision module is a video-based system, that utilises sensors that provide feedback relating to the position of the blast hole 9. In this way, the positioning unit 94 can be an autonomous positioning unit. Alternatively, the positioning unit 94 can be a semi-autonomous positioning unit, with an operator controlling the positioning unit remotely via cameras.

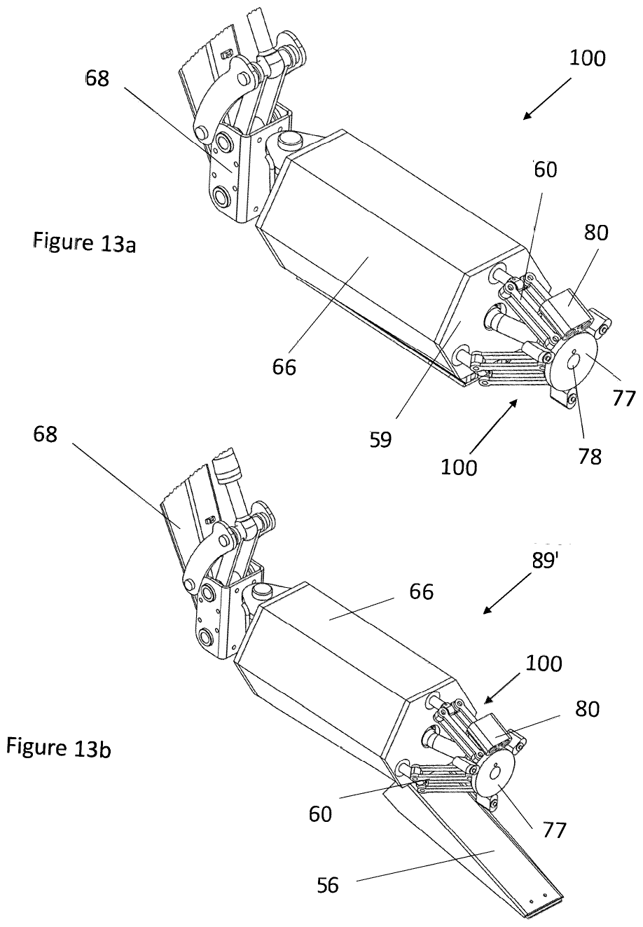

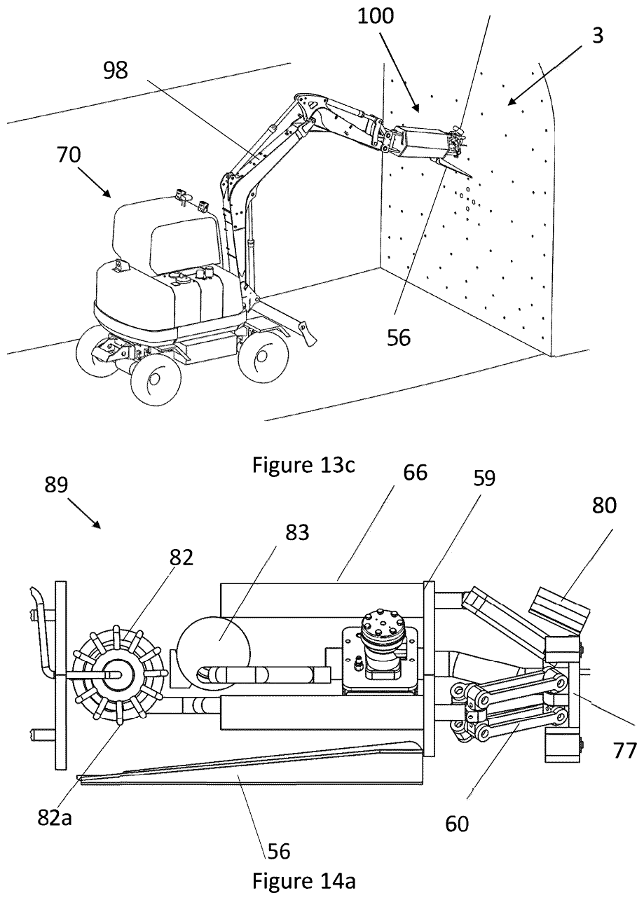

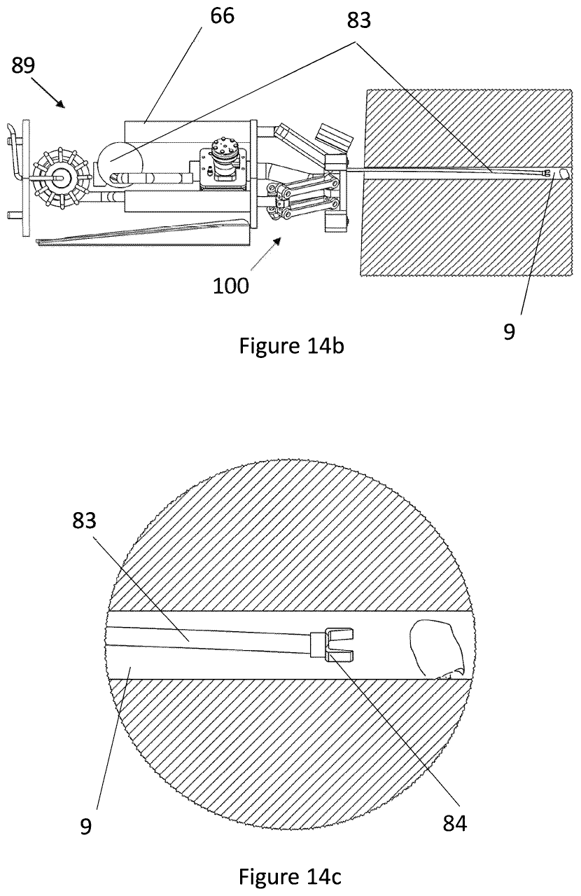

The vision module 76,80 includes a coarse range sensor 76a (see FIGS. 13 and 14) that is mounted to a body or chassis of the vehicle 70 and a fine range sensor 80 that is mounted to the fine positioning module 100. In this way, the coarse range sensor 76a serves to monitor and guide the coarse positioning module 68 whilst the fine range sensor 80 monitors and guides the fine positioning module 100. The range sensors can be, for example, 3D imaging sensors, cameras, proximity sensors and the like.

### The Functional Units 89′, 89″

The functional units 89′, 89″ are essentially tools or end-effectors which are selectably couplable to the positioning unit 94 of the or each vehicle 70, 70′.

Each functional unit 89′, 89″ is configured to undertake a particular function-related or task-related to working the rock face 3 and/or loading the trigger assembly 7 into the blast hole 9. The vehicle or vehicles 70,70′ may include a store or container 58 for holding several different functional units 89′, 89″.

The functional units 89′, 89″are configured to handle all movements that directly interact with the trigger assembly 7. In this way, the fine 100 and coarse positioning modules 68 do not directly interact with the trigger assembly 7.

Accordingly, it is understood that in some functional units 89′, 89″ are configured to be independently moveable with respect to the vehicle positioning unit 94. In this way, a functional unit 89′, 89″ may, for example, move the trigger assembly 7 forward within the blast hole 9 whilst the positioning unit 94 of the vehicle 70, 70′ (i.e. the fine and coarse positioning modules 100, 68) remains parked. Thus, the forces and torques applied to the trigger assembly 7 by the arm 98 of the vehicle 70,70′ are limited to those of functional units 89′, 89″ themselves. Such forces are significantly (in some cases orders of magnitude) lower than that of the respective positioning modules 94, protecting from inadvertent mishandling of the explosives and/or other delicate components.

A functional unit 89 of the first vehicle 70 is shown in FIGS. 13 to 14. This functional unit 89 is an integrated face and hole preparation unit. The functional unit 89′ comprises a rake member 56 that is coupled to the fine positioning module 100 and at least one hose assembly 66. The rake member 56 may be hingedly attached to the positioning module 100, such that it can move between an operable extended position for working the rock face 3 (shown in FIG. 13b), and a retracted or stowed position (shown in FIG. 13a), for when the rake member 56 is not in use.

In other embodiments (not illustrated), the face and hole preparation units may be provided as separate functional units 89, that is a functional unit 89 for preparing the rock face 3 and a separate functional unit for cleaning the blast hole 9.

In use, the first vehicle 70 (with the functional unit 89 coupled thereto) is trammed into position outside the safety risk zone, typically at least 5 m from the heading 11. With the rake member 56 extended (as shown in FIG. 13b), it is slid—via the positioning module 94—along the rock face 3 proximate or adjacent to the blast hole 9. In this way, the rock face 3 is wiped clear of debris, in preparation for insertion of the trigger assembly or assemblies 7 into respective blast holes 9. The cleaning process is best shown in FIG. 13c.

Turning now to FIGS. 14a to 14c, the hose assembly 66 includes a hose 82 supplied via a rotatable spool 82a of the integrated functional unit 89. The hose 82 is configured to clean debris from within the hole 9. Specifically, after the rock face 3 has been cleared of debris, the rake member 56 is retracted, enabling the functional unit 89 to be positioned proximate the hole 9. The hose 82 is then selectively fed into the hole 9. The hose 82 is a pneumatic hose, that includes an air jet 81, disposed at an end thereof. Activation of the air jet 81 creates fluid pressure within the hole 9, loosening and clearing debris from the hole 9. The air jet 81 is directed rearwardly, such that debris is blown towards and out of the open or proximal end of the hole 9. The components of the hose assembly 66 are best shown in FIG. 14a.

Feeding the hose 82 into the hole 9 is a selective feeding operation from the spool 82a that has an encoder or other mechanism for determining a length of the hose 82 that has been dispensed therefrom and into the hole 9. In this way, the length of the hose 82 within the hole 9 can be determined and compared to a known pre-drilled depth of the hole 9. This acts as a verification that the hole 9 is clear of debris or other obstacles, and thus ready for the trigger assembly 7 to be inserted therein, with the knowledge that the trigger unit 17 thereof will be able to be moved into the detonation position.

Should an obstacle or debris be detected, however (i.e. if the length of hose dispensed into the hole is less than the pre-drilled, known depth thereof) a second hose 83 of the functional unit may be required. With reference to FIGS. 14b and 14c, the second hose 83 is used for clearing heavy debris such as rock from within the hole 9. The second hose 83 includes a claw 84 that is configured to grasp around the heavy debris, removing it from the hole 9. Once the heavy debris has been cleared, the first hose 82 is reinserted to verify that the hole 9 is now clear and ready to receive the trigger assembly 7.

With the hole 9 now clear of debris, the same hole cleaning functions are repeated on each of the holes 9. When all the holes 9 are cleaned, the first vehicle 70 is trammed out of the drive and the second vehicle 70′ is trammed into position outside the safety risk zone.

The second vehicle 70′ includes a different functional unit 89′ coupled to the fine movement module 100.

This alternate functional unit 89′ is shown in FIGS. 16a-16d. The functional unit 89′ includes the above-described housing 93 and gripper unit 95 configured to retain and support a trigger assembly 7 to be placed within the hole 9.

As described above, the procedure to locate a trigger assembly 7 (with a booster 19) in a hole includes a first step of an operator manually removing a booster 19 and a trigger assembly 7 from their separate storage compartments 96a, 96b and inserting the booster 19 into the trigger assembly 7. It is noted that this step may be automated in the future.

The assembled trigger assembly 7 is then loaded into the housing 93 of the functional unit 89′ and retained by the housing 93 and closed gripper arm unit 95 in a loading position of the functional unit 89′ proximate the second vehicle 70′. This loading step is shown in FIG. 16b.

Once the trigger assembly 7 is within the housing 93, the articulated arm 98 is operable to move the trigger assembly 7 from the assembly area on the vehicle 70′ and position the functional unit 89′ in an aligned position in relation to the hole 9, with the functional unit 89′ then being operable to move the trigger assembly 7 within the hole 9 in an initial deployment position within the hole 9. To do so, the coarse positioning module 68 is activated, transporting the functional unit 89′ (and housed trigger assembly 7) to a pre-insertion position, proximate the hole 9, as shown in FIG. 16c. The fine positioning module 100 is activated next, such that the trigger assembly 7 is aligned co-axially with the hole 9. Finally, the emulsion hose 86 is activated, extending through the opening of the gripper unit 95, such that the trigger assembly 7 is pushed into the hole 9 to the initial position, the collar 25 engaging with the rock face 3 such that the trigger assembly 7 is retained therein. This initial position is best shown in FIG. 16c.

Once the trigger assembly 7 is in the initial position proximate the opening of the hole 9, the trigger unit 7 is pushed forward within the hole 9 to the detonation position via a pusher or insertion mechanism 87. Best shown in FIGS. 16d and 16e, this is achieved with the emulsion charging hose 86. In use, the emulsion charging hose 86 is threaded through the aperture 78 of the platform 77 of the fine positioning module 100 and into the opening at the proximal end of the detonation unit body 21 and unspools through the housing 23. As the hose 86 passes through the housing 23, it pushes against the trigger unit 17, urging it forward against the frangible wall 35. The force of the trigger unit 17 against the frangible wall is sufficient to displace the wall 35, such that the trigger unit 17 is pushed, by the hose 86, to the detonation position. At this point, the emulsion charging hose 86 can be withdrawn, delivering the explosive emulsion to the hole 9, ready for triggering via the trigger unit 17.

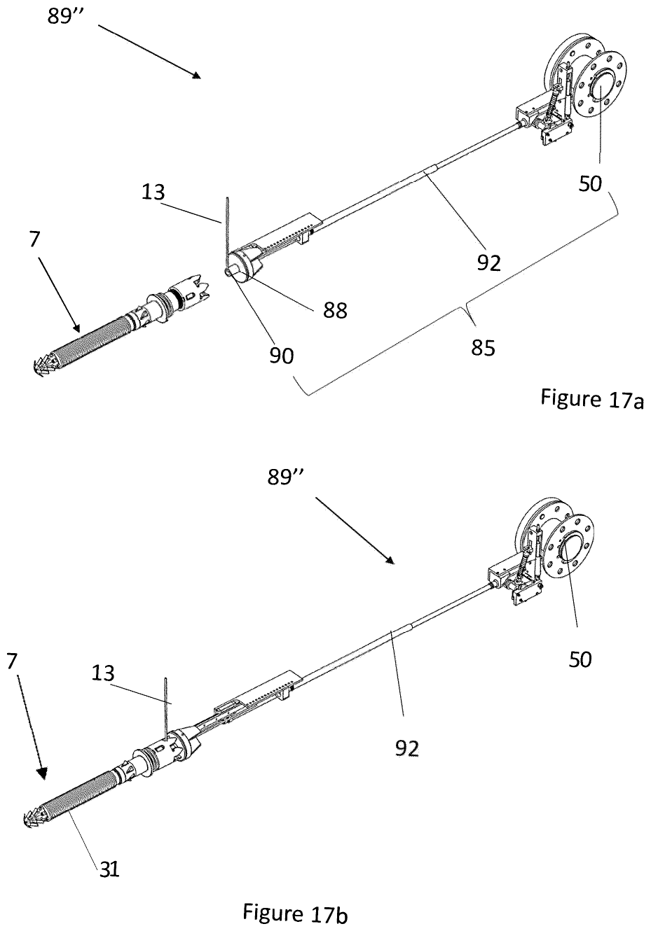

Turning now to FIGS. 17a and 17b, which show a further functional unit 89′, coupled to the fine movement module 100 of the second vehicle 70′. The functional unit 89″ includes the tie-in module 85 that is configured to physically interconnect a plurality of deployed trigger assemblies 7 together via the detonation cord 13. In use, the tie-in module 85 is connected to the fine positioning module 100 once each of the required trigger assemblies 7 are installed within their respective blast holes 9.

The tie-in module 85 comprises a disc shaped moveable head 88 and a rotatable drum 50. The rotatable drum 50 provides a supply of detonation cord 13. Best shown in FIG. 17a, the moveable head 88 includes a guide 90 through which the detonation cord 13 is selectively dispensable. The head 88 is attached to a telescopic tube 92 that provides independent forward and rearward movement thereof whilst the functional unit 89″ itself remains stationary—FIG. 17b shows the extension of the telescopic tube 92 resulting in the driving forward of the head 88 towards the trigger assembly 7.

Referring now to FIGS. 18a to 18d. The moveable head 88 is configured to engage with the connection unit 27 of the trigger assembly 7. Specifically, in use, the moveable head 88 is configured to apply an axial force to the connection unit 27, which moves the connection unit 27 from the first inoperative position to the second operative position. As shown in FIGS. 18a and 18b, the head 88 is moved towards the connection unit 27 by the telescopic tube 92.

Once contacting the connection unit 27, the detonation cord 13 is selectively dispensed from the rotatable drum 50 and threaded through opposing channels 67 of the connection unit 27 of the trigger assembly 7. After the detonation cord 13 has been dispensed, the head 88 drives forward again, pushing the connection unit 27 axially along detonation unit body 21 from the first inoperable position to the second, operable position. As the connection unit 27 is driven forwards, it rotates into position, the projecting members 65 being aligning with the slots 71, with the detonation cord 13 being secured and locked within a notch thereof 69. In this way, the detonation cord 13 is physically locked in place within the notch of the respective connection units 27 of each trigger assembly 7. The head 88 is then retracted, with the detonation cord 13 remaining in place on the connection unit 27, as shown in FIG. 18c.

As shown in FIG. 18d, the detonation cord 13 is physically connected to the trigger cord 31 of the trigger assembly (As can be appreciated from FIG. 18d and earlier sections of the specification, such as FIG. 4c, where the detonation cord 13 is physically connected to the trigger cord 31 of the trigger assembly that is positioned in the channel 47). Thus, the trigger unit 17 of each trigger assembly 7 is now operably connected to the activation means, and ready for the controlled blast.

With reference to FIGS. 19a and 19b, this tie-in process is then repeated, with the detonation cord 13 being continuously threaded through the connection unit 27 of respective trigger assemblies 7 within the rock face 3—with the positioning unit 94 of the vehicle 70′ moving the functional unit 89′ into alignment with each of the subsequent trigger assemblies 7. In this way, each of the trigger assemblies 7 within the rock face 3 are operably joined together to the activation means, via the detonation cord 13.

It is noted that the tie-in module 85 as described is used for instances where the connection of the trigger unit 17 to the external activation means is a physical connection. Where the connection is a wireless connection, the tie-in module 85 need not comprise the rotatable drum 50 and associated detonation cord 13. Rather, said tie in module 85 would be limited to mechanical means of moving the connection unit 27 to the operative position, such that the external connection means is operably connected with the trigger unit 17 of the trigger assembly 7.

### Operation and Working of the Vehicles 70

A preferred or exemplary working process involving the two vehicles 70, 70′ will now be described. Generally speaking, this process involves the following steps or stages:
i. inspecting the rock face 3 of the heading 11;
ii. cleaning debris from the rock face 3;
iii. inspecting the holes 9 within which the trigger assemblies 7 are to be installed;
iv. cleaning the holes 9 in preparation for receiving the trigger assembly 7;
v. assembly of the detonation systems of each trigger assembly 7;
vi. installation/placement of the trigger assemblies 7 in the holes 9;
vii. delivering emulsion explosive into the holes 9; and
viii. tie-in of the respective detonation systems of each of the trigger assemblies 7.

The above stages are somewhat analogous to the stages of conventional blasting methods of drive advancement. The difference in this process lies in the fact that each of the stages (i) to (viii) above are mechanised, involving the use of vehicles 70, 70′. In this way, workers/persons can be kept a safe distance away from the heading 11, whilst the efficiencies of automation result in faster advancement.

Without being limited to this preferred method, it is understood that stages (i) to (iv) utilise the “face inspection” or first vehicle 70, whilst stages (v) to (viii) utilise the “explosive charging” or second vehicle 70′.

During step (i), the face inspection vehicle 70 is driven or trammed along the drive to a position proximate the heading 11. This may be an autonomous or semi-autonomous process, whereby the vision module 76 provides location related feedback to an operator or controller or the vehicle 70. In particular, the coarse range sensor 76a is used for this purpose. Once in position, the articulated arm 98 of the vehicle 70 is extended, such that the fine range sensor 80a is moved to a location close or adjacent to the heading 11. The coarse positioning module 68 is then activated, such that the articulated arm 98 is moved across the surface of the heading 11. During this movement, the vision module 76 is used to perform a preliminary surface scan of the heading 11. This scan is used to determine the existence of surface debris and the like, and any particular areas requiring smoothing and clearing. During this movement, the vision module 76 also scans the rock face 3 of the heading 11 to identify and locate the pre-drilled holes 9 within the face 3. This location data is stored within a controller of the vehicle 70. The scanning operation relies upon algorithms within the controller to identify the holes within the face. Alternatively, the controller may already have predetermined hole location data stored therein, in which case the scanning operation is used to confirm or verify the location of the holes 9. It is noted that this identification/locating of the hole locations can also be done after the heading 11 has been cleared, as part of step (iii).

Once the scan of the rock face 3 is completed, step (ii) commences. During this step, debris is removed from the rock face 3 or heading 11. Step (ii) utilises the rake member 56 of the integrated functional unit 89. In particular, the rake member 56 is extended to an operable position, with the coarse movement module 68 being activated to move the articulated arm 98 of the vehicle 70 across the rock face 3 in a sweeping motion. The sweeping motion may be a substantially vertical motion or, alternatively, a horizontal motion. This sweeping movement brushes debris from the rock face 3. The removal of debris is a quality issue, and important to allow safe and accurate placement of the trigger assemblies 7 within the holes 9. The surface of the ground of the drive adjacent the heading 11 is also flattened and cleared by the rake member 56 in a similar process.

With the heading 11 has been cleared of debris, it is now time for step (iii), where the holes 9 are inspected for debris. Specifically, the fine positioning module 100 is activated and used to locate the aperture 78 of the platform 77 coaxially with the hole 9. The first hose 82 is then selectively fed from the spool 82a through the aperture 78 and into the hole 9. As the hose 82 is fed into the hole 9, the length of hose 82 is determined via an encoder or similar on the spool 82a. The hose 9 is fed until it encounters a resistance. The resistance can, for example, be the end of the hole 9. The length of unspooled hose 82 is then compared with a known depth or length of the hole 9. The known depth of the hole 9 is stored within a controller of the vehicle 70 or on a chart available to an operator thereof. If the length of hose 80 is substantially the same as the known length, it is determined that the hole 82 is clear. If, however, the length of hose dispensed is less than the known length of the hole 9, it can be determined that there is an obstruction that requires clearing. It is important to clear the hole 9 of such obstruction, for the trigger assemblies 7 need to be positioned at known locations—nominally towards the end of—the holes 9.

Step (iv) involves the clearing of debris and obstacles from the hole 9. A first aspect of step (iv) is undertaken simultaneously with the depth measurement of step (iii). Specifically, the air jet 81 is incorporated into the end or head of the hose 82. As the hose 82 is retracted back towards the front or proximal end of the hole 9, the air jet 81 is activated, such that mild or small debris such as sand and small stones are blown towards the hole face. A second aspect of clearing the hole 9 of debris, however, involves a separate or distinct cleaning step. This cleaning step is undertaken when an obstruction is detected during step (iii). Specifically, after the first hose 82 is retracted, the second hose 83 is fed into the hole 9. Upon encountering the previously detected obstruction, the claw 84 is activated, grasping the obstruction (i.e. stones, rocks, debris) therein. The hose 83 is then retracted and with it the debris. This may be repeated several times as necessary. To ensure that the obstruction has been cleared, step (iii) can be repeated after the second hose 83 has been used.

At the completion of steps (i) to (iv) for all holes 9 within the heading 11, it is time for the trigger assemblies 7 to be prepared and inserted. The first vehicle 70 is driven or trammed clear, with the second vehicle 70′ being driven or trammed into its place proximate the heading 11. The second vehicle 70′ includes the first storage compartment or housing 96a within which the plurality of pre-assembled trigger assemblies 7 are housed (the boosters 19 are housed in the separate compartment or housing 96b of the second vehicle 70′). The connection units 27 of the pre-assembled assemblies 7 are in the first inoperative position—i.e., only partially engaged with the detonation unit.

The pre-assembled trigger assemblies 7 are fitted with colour coded connection units 27. The colour coding is used to assist the operator/controller of the vehicle 70′ with locating the correct trigger assemblies 7 into the correct holes 9. For example, the colour coding may indicate the type of booster to be installed therein or the length of nonel cord 31 wrapped around (i.e., determining the depth at which the respective trigger assembly is to be located). Alternatively, or additionally, the colour coding may indicate the timing of the detonation if the trigger unit 17—i.e., the “order” in which the trigger assemblies 7 are fired after activation via the external activation means. Alternatively, it is also contemplated that the trigger assemblies 7 may be programmable trigger assemblies, with the timing of fire being based on the location of the hole 9 within which the trigger assembly 7 is inserted—as such placement of specific trigger assemblies in specific holes based on timing/sequence of fire is no longer necessary.

Step (v) comprises assembling the trigger units 17 of each of the trigger assemblies 7. In particular, the booster 19 is inserted into the compartment of the trigger assembly. When positioned within the compartment 22, the detonator 15 (being pre-installed within the trigger assembly 7) is at least partially enveloped within the chamber 22 of the booster 19. Notably, prior to this step, the trigger units 17 of each trigger assembly 7 are not operable/assembled, with the explosive (i.e., booster 19) being located separate from the detonator 15. This step may be a manual step, undertaken by an operator. A T-shaped insertion tool 28 may be used by the operator to push the booster through the connection unit 27 and housing 23 into position within the compartment 22. Alternatively, this may be an automated step undertaken by a functional unit 89′ of the second vehicle 70′. In either event, it is preferred that during assembly, the trigger assemblies 7 are supported on the slider 91a of the hand off unit 91, in an assembly position that is away from the positioning unit/articulated arm of the vehicle 70′. Once the trigger unit 17 is assembled with the booster 19 therein, the carriage 91b of the hand off slider 91a is activated, and the assembled trigger assembly 7 is moved to a hand-off position.

With the assembled trigger assembly 7 in the hand off position, it is time for the trigger assembly 7 to be positioned within the hole 9. During step (vi), the gripper 95 of the functional unit 89′ is initially moved into a loading position proximate to the hand off slider 91a. In this loading position, the opening of the housing 93 is concentrically aligned with the connection unit 27 of the trigger assembly 7. The carriage 91b of the hand off slider 91a is activated once more and the gripper 95 opened, such that the trigger assembly 7 is fed into the housing 93. The gripper 95 is then closed, such that the trigger assembly 7 is secured within the housing 93. The carriage 91b of the slider 91a is then retracted clear of the gripper 95. The coarse movement module 68 is then activated, with the articulated arm 98 moving the gripper 95 to the unloading position, proximate the hole 9. The fine positioning module 100 is then activated, such that the gripper 95 (and trigger assembly 7 within the housing 93 thereof) is coaxially aligned with the hole 9. At this point, the jaws of the gripper 95 are opened, with the pusher 86 inserting the trigger assembly 7 into the initial position within the hole 9. In this initial position. The respective connection units 27 protrude outwardly from the hole 9, whilst the housing 23 of the trigger assembly 7 extends into the hole 9, being retained in position relative thereto via the collar 25, which engages against the sides of the hole 9.

Once in the initial position, the trigger unit 17 is then moved forward towards its operative or detonation position via the emulsion charging hose 86. Specifically, the charging hose 86 is fed through the opening of the connection unit 27, and contacts against a proximal end of the booster 19. Continued feeding of the charging hose 86 pushes the trigger unit 17 of the trigger assembly 7 free of the housing 23 to the detonation position, with the housing 23 being retained at the proximal end of the hole 9 via the collar 25.

With the trigger unit 17 now in the detonation position, step (vii) involves the pumping of emulsion explosive, via the charging hose 86 into the hole 9. Advantageously, because the charging hose 86 is used to position the trigger unit 17 in the detonation position, the charging hose 86 is already located within the hole 9, saving time and effort required to otherwise feed the hose 86 therein. Once the emulsion explosive is fed into the hole 9, the hose 86 is retracted.

Steps (i) to (vii) are then repeated for all trigger assemblies 7, such that each hole 9 within the heading 11 receives a trigger assembly 7.

Finally, step (viii) involves the “tie in” of the trigger cords 31 of each of the trigger assemblies 7. This step is conducted via the tie-in module 85 of the functional unit 89″. It is understood, therefore, that it may be necessary for an intermediary step of changing or “swapping out” the functional unit 100′ in order for the functional unit 100″ to be coupled to the articulated arm. Alternatively, the functional unit 100″ can be adapted to work alongside the functional unit 100′. For example, the tie-in module 85 can be adapted so as to be receivable around an outside of the housing 93 of the functional unit 100′. In such an embodiment, the tie-in module can be installed into position via the slider unit 91 in a similar manner to the way in which the trigger assemblies 7 are received within the housing 93.

The tie-in module 85 is then moved into an operable tie-in position, proximate the connection unit 27 of a first of the trigger assemblies 7. As previously discussed, in the case of a physical connection between the external activation means and the trigger unit 17, the detonation cord 13 is selectively dispensed from the rotatable drum 50 and threaded through opposing channels 67 of the connection unit 27 of the first of the trigger assembly 7. The connection unit 27 is then moved from the inoperative position to the operative position via the moveably head 88 of the tie-in module 85.

This process is then repeated, with the tie-in module 85 being moved to a second tie-in position, such that the detonation cord 13 is continuously threaded through the connection unit 27 of respective trigger assemblies 7 within the rock face 3. In this way, each of the trigger assemblies 7 within the rock face 3 are operably joined together to the activation means, via the detonation cord 13, ready for detonation.

Summarily, it is understood that the present invention provides a device for installing a protective lining to an underground drive such as a mining drive, that provides significant safety and productivity improvements over existing manual methods. Conventional industry practise requires workers to work underground to manually unroll and fix protective mesh to the drive surfaces, an arduous task with a high level of injury risk. The present invention overcomes these problems by providing an assembly that enables this task to be undertaken by an otherwise conventional rock drilling jumbo. The assembly includes a pair of arms couplable to a boom of the jumbo, for holding a roll of protective lining therebetween. The arms are configured such that throughout the installation process, the roll of lining is held clear of the boom and the remainder of the jumbo, reducing the chance of damage to both the jumbo and the lining itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Many modifications may be made to the embodiments described above in relation to the Figures without departing from the spirit and scope of the invention.

By way of example, the invention is not confined to a two-vehicle solution and other possible embodiments are single vehicle embodiments, for example, with separate arms carrying functional units for hole cleaning, etc.

1.-71 (canceled)

72. A mining or civil engineering vehicle for working proximate a hole, the vehicle comprising a positioning system for moving a functional unit to a selected location, the positioning system including:
(i) a coarse positioning module configured to position the functional unit proximate the selected location; and
(ii) a fine positioning module configured to facilitate adjustment of the position of the functional unit to locate and align the functional unit more accurately in relation to the selected location.

73. The vehicle defined in claim 72, wherein the coarse positioning module and the fine positioning module comprise a single module with two functions.

74. The vehicle defined in claim 72, wherein the positioning system further includes a control system that can track the selected location, for example by video servo methods or similar hole monitoring options, and operate the fine positioning module to adjust, typically continuously, the position of the functional unit.

75. The vehicle defined in claim 72, wherein the positioning system further includes a system for monitoring the position of at least one of the coarse positioning module and the fine positioning module.

76. The vehicle defined in claim 75, wherein the system comprises at least one of a first range sensor mounted to a body of the vehicle and a second range sensor mounted to the fine positioning module.

77. The vehicle defined in claim 72, wherein the fine positioning module comprises a hub configured to be coupled to the functional unit and a plurality of elongate links, with each link being connected at one end to the hub.

78. The vehicle defined in claim 77, wherein each of the links is independently moveable such that the hub is translatable and rotatably moveable with respect to the vehicle.

79. The vehicle defined in claim 77, wherein the hub includes an aperture that, in use, is aligned co-axially with the hole.

80. The vehicle defined in claim 72, further including at least one functional unit configured to handle an explosive associated with a trigger assembly, and wherein the at least one functional unit is configured to move the trigger assembly with respect to the hole independently of the positioning system of the vehicle.

81. The vehicle defined in claim 80, comprising a first functional unit including (a) a housing for protecting the trigger assembly in use of the functional unit to position the trigger assembly in the hole and (b) a gripper unit positioned at an opening of the housing, with the gripper unit being movable between closed and open positions to allow insertion of the trigger assembly into the housing.

82. The vehicle defined in claim 81, wherein the first functional unit, typically couplable to the fine positioning module, is configured to support the trigger assembly when the trigger assembly is moved to an initial position within the hole.

83. The vehicle defined in claim 81, wherein the first functional unit includes a moveable member that, in-use, is moved co-axially with the hole to move the trigger assembly from a pre-insertion position proximate the hole to an initial position within the hole.

84. The vehicle defined in claim 81, wherein the first functional unit includes an insertion mechanism operable to move a detachable portion of the trigger assembly forward from an initial position to an operative position within the hole.

85. The vehicle defined in claim 84, wherein the insertion mechanism comprises a hose that extends to push the detachable portion from the initial position to the operative position, and the hose extends through an aperture of a hub of the fine positioning module.

86. The vehicle defined in claim 80, including a second functional unit in the form of a tie-in module that is typically couplable to the fine positioning module and configured to connect a detonation cord to the trigger assembly after the trigger assembly is located in the hole.

87. The vehicle defined in claim 86, wherein the tie-in module includes a moveable head that is engageable with a fixed portion of the trigger assembly, such that, in use, forward movement of the moveable head secures the detonation cord to the trigger assembly, and wherein the head is attached to a telescopic tube to facilitate forward movement thereof.

88. The vehicle defined in claim 87, wherein the moveable head includes a guide through which the detonation cord is fed towards the fixed portion of the selected trigger assembly.

89. The vehicle defined in claim 86, wherein the tie-in module includes a rotatable drum from which the detonation cord is selectively dispensable.

90. The vehicle defined in claim 80, including a third functional unit configured to clean and inspect the hole and/or the rock face surface proximate thereto in preparation of insertion of a trigger assembly.

91. The vehicle defined in claim 80, including a fourth functional unit couplable to the fine positioning module and configured to clear debris from within the hole, the fourth functional unit including a first hose that is fed into the hole, and wherein a terminal end of the first hose provides an air jet for clearing light debris from the hole.

92. The vehicle defined in claim 91, wherein the air jet is directed away from the terminal end of the first hose, such that debris is propelled towards the opening of the hole.

93. The vehicle defined in claim 91, wherein the fourth functional unit includes a second hose having a terminal end configured to grasp heavy debris and remove it from the hole.
